(19) United States
(12) Patent Application Publication
(10) Pub. No.: US 2025/0256515 A1
(43) Pub. Date: Aug. 14, 2025

(54) PACKING SYSTEMS AND METHODS, AND BARCODE MASKING APPARATUS FOR THE SAME

(71) Applicant: WestRock Packaging Systems, LLC, Atlanta, GA (US)

(72) Inventors: Jean-Christophe BONNAIN, Châteauroux (FR); Cedric VOSGEOIS, Villefranche sur Cher (FR); Barbara LUCHE, Vouillon (FR)

(21) Appl. No.: 18/702,833

(22) PCT Filed: Oct. 20, 2022
(86) PCT No.: PCT/US2022/047330

§ 371 Date: Apr. 19, 2024

Related U.S. Application Data
(60) Provisional application No. 63/257,874, filed on Oct. 20, 2021.

(51) Int. Cl. B41J 3/407; B65B 35/46; B65B 35/58

(52) U.S. Cl. CPC B41J 3/40733; B65B 35/46; B65B 35/58

(57) ABSTRACT

A masking module includes a masking apparatus situated proximate to a path of a container. The masking apparatus is configured to apply a mask to at least a portion of a barcode of the container as the container travels along the path. The masking module also includes a controller in communication with the masking apparatus. The controller is configured to selectively actuate the masking apparatus when the container passes by the masking apparatus along the path.

### CROSS-REFERENCE TO RELATED APPLICATION

The present application claims the benefit of priority to U.S. Provisional Patent Application Ser. No. 63/257,874 filed on Oct. 20, 2020, the entire contents of which is incorporated herein by reference in its entirety.

### FIELD

The present disclosure relates to packing systems and methods and, more particularly, to systems and methods for orienting and packing containers and barcode masking apparatus for masking at least a portion of a barcode applied to a container.

### BACKGROUND

In the field of packaging, it is often desirable to provide a package including multiple primary product containers, such as multi-packs, for shipping and distribution and for display of promotional information. It is also often desirable to present the packaged containers in a particular orientation. It is also often desirable to mask the barcode of individual containers in the packaged multi-pack of containers. Most often, barcode masking is addressed using a physical element of the container packaging (e.g., a carton or carrier), such as a panel or other portion of the packaging, to block or reveal the relevant barcode. However, this solution typically increases material costs associated with the physical element of the packaging used to bock the barcode and increases processing times, costs and complexities related to forming the packaging and applying the packaging to a group of containers. Accordingly, those skilled in the art continue with research and development efforts in the field of container packaging and barcode masking.

### SUMMARY

Disclosed are a system for packaging containers, a masking module for masking at least a portion of a barcode applied to a container and a method for packaging containers. The following is a non-exhaustive list of examples, which may or may not be claimed, of the subject matter according to the present disclosure.

In an example, the disclosed masking module includes a masking apparatus situated proximate to a path of a container. The masking apparatus is configured to apply a mask to at least a portion of a barcode of the container as the container travels along the path. The masking module also includes a controller in communication with the masking apparatus. The controller is configured to selectively actuate the masking apparatus when the container passes by the masking apparatus along the path.

In an example, the disclosed system includes an orienting module configured to receive a container, to guide the container along a portion of a path, and to orient the container in a masking orientation at a masking location along the path. The system also includes a masking module configured to apply a mask to at least a portion of a barcode of the container as the container passes the marking location along the path.

In an example, the disclosed packaging method includes steps of: (1) receiving a container; (2) moving the container along a path; (3) scanning the container as the container moves along the path; (4) calculating a first orientation adjustment from an initial orientation to a masking orientation for the container; (5) rotating the container to effectuate the first orientation adjustment; and (6) masking at least a portion of a barcode of the container.

Other examples of the disclosed system, masking module and method will become apparent from the following detailed description, the accompanying drawings, and the appended claims.

### BRIEF DESCRIPTION OF THE DRAWINGS

FIG. 1 is a schematic, perspective view of an example of a portion of a system for packaging containers;

FIG. 2 is a schematic, top plan view of an example of a portion of the system;

FIG. 3 is a schematic, top plan view of an example of a portion of the system;

FIG. 4 is a schematic, top plan view of an example of a portion of the system;

FIG. 5 is a schematic, top plan view of an example of a portion of the system;

FIG. 6 is a schematic, top plan view of an example of a portion of the system;

FIG. 7 is a schematic, top plan view of an example of a portion of the system;

FIG. 7A is a schematic illustration of an example of a portion of a metering screw of the system;

FIG. 7B is a schematic illustration of an example of a portion of a star-wheel of the system;

FIG. 7C is a schematic illustration of an example of a portion of the star-wheel of the system;

FIG. 8 is a schematic, top plan view of an example of a portion of the system;

FIG. 8A is a schematic illustration of an example of a portion of the metering screw of the system;

FIG. 8B is a schematic illustration of an example of a portion of the star-wheel of the system;

FIG. 8C is a schematic illustration of an example of a portion of the star-wheel of the system;

FIG. 9 is a schematic, top plan view of an example of a portion of the system;

FIG. 9A is a schematic illustration of an example of a portion of the metering screw of the system;

FIG. 9B is a schematic illustration of an example of a portion of the star-wheel of the system;

FIG. 9C is a schematic illustration of an example of a portion of the star-wheel of the system;

FIG. 10 is a schematic, perspective view of an example of an orienting module of the system;

FIG. 11 is a schematic, perspective view of an example of a portion of the orienting module;

FIG. 12 is a schematic, top plan view of an example of a grouping module of the system;

FIG. 13A is a schematic, top plan view of an example of a portion of the grouping module;

FIG. 13A is a graphical representation of an example of a velocity profile for lugs and grippers of the grouping module;

FIG. 14 is a schematic, perspective view of an example of a portion of the system;

FIG. 15 is a schematic, perspective view of an example of a portion of the system;

FIG. 16 is a schematic, perspective view of an example of a gripper of the system;

FIG. 17 is a schematic, perspective view of an example of a portion of the system;

FIG. 18 is a schematic, top plan view of an example of a portion of the system;

FIG. 19A is a schematic, perspective view of an example of a portion of the system;

FIG. 19B is a schematic, perspective view of an example of a container with a portion of a barcode masked; and

FIG. 20 is a schematic, perspective view of an example of a portion of the system;

FIG. 21 is a schematic, top plan view of an example of a portion of the system;

FIG. 22 is a schematic, perspective view of an example of a portion of the system;

FIG. 23 is a flow diagram of an example of a method for packaging containers.

### DETAILED DESCRIPTION

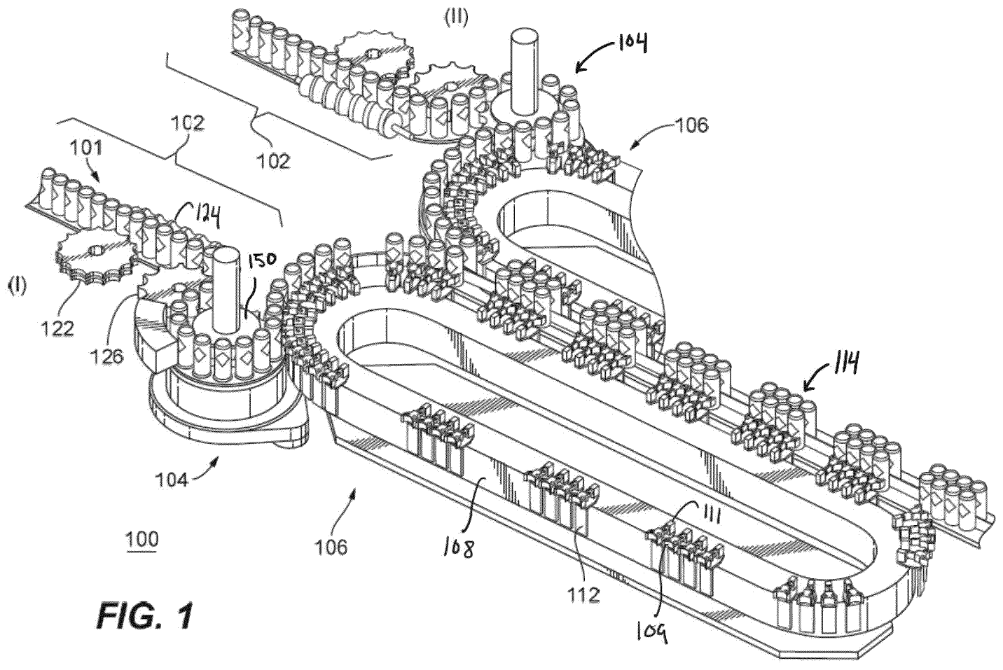

Referring generally to FIGS. 1-22B, by way of examples, the present disclosure is directed to system 100 for packaging containers 101 (herein below referred to collectively as containers and individually as container). More particularly, examples of system 100 enable orienting, grouping, and packing of containers 101 to create packages or packs of containers 101. More particularly, examples of the system 100 enable masking of at least a portion of a barcode of container 101 during the packaging process. For example, system 100 facilitates metering of a stream of containers 101, orienting each one of containers 101 is a desired first orientation, masking the barcode of each one of containers 101 in the desired first orientation, and orienting containers in a desired second orientation for grouping and packing containers 101.

System 100 and, more particularly, an orienting module and a masking module of the system 100 advantageously avoids various challenges, complexities and undesirable increases in processing time and cost associated traditional barcode masking techniques, such as altering article carriers, while providing barcode masking at a high speed.

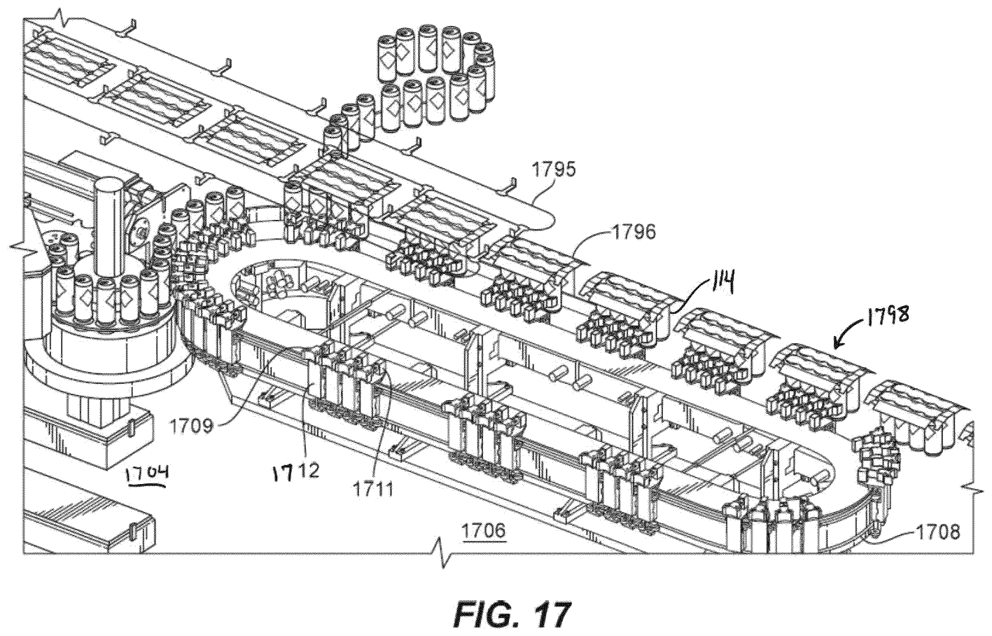

Referring now to FIG. 1, which illustrates an example of a portion of system 100. Generally, as illustrated in FIG. 1, system 100 is configured to receive a stream of containers 101, to orient each one of containers 101 into a desired direction and/or orientation and to maintain each one of containers 101 in the desired direction and/or orientation while packaging containers 101 into packs 114 (e.g., as shown in FIG. 1) or packages 1798 (e.g., as shown in FIG. 17).

In one or more examples, system 100 includes two sets of modules (e.g., a first module set I and a second module set II). In one or more examples, each set of modules is a mirror of the other. For example, each set of modules includes the same three types of modules. Each of the modules of the set of modules, the details and capabilities of each module and various example configurations of each module are described herein below.

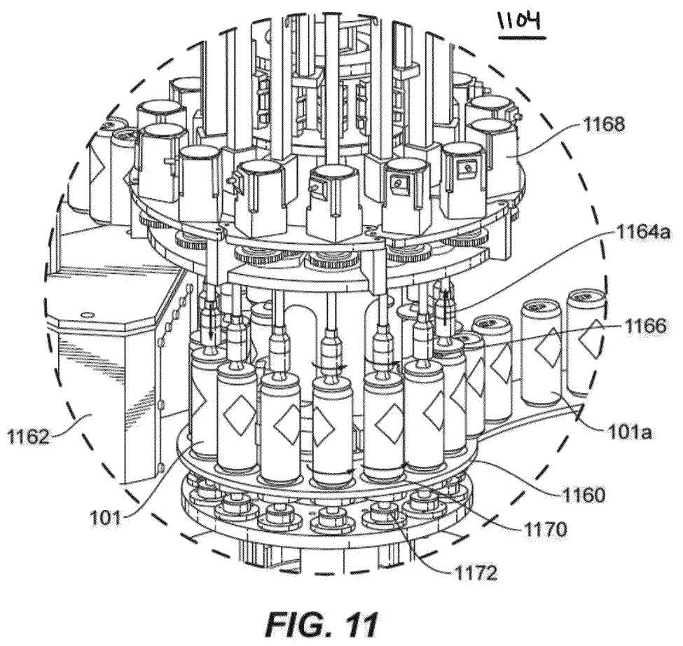

In one or more examples, each set of modules (e.g., the first module set I and/or the second module set II) includes conveying module 102, orienting module 104 and grouping module 106. In one or more examples, conveying module 102 is configured for supplying containers 101, for example, as a stream of containers 101. In one or more examples, orienting module 104 is configured for scanning and orienting containers 101. In one or more examples, grouping module 106 is configured for organizing containers 101 in the desired orientation (e.g., oriented containers 101a as shown in FIG. 11) into groups and/or packs 114.

In FIG. 1, conveying module 102, orienting module 104 and grouping module 106 of the first module set I are shown and labelled. In FIG. 1, conveying module 102, orienting module 104 and a portion of grouping module 106 of the second module set II are shown. Although two sets of modules (e.g., module set I and module set II) are shown in FIG. 1, each module in the subsequent figures and in the description below may be discussed as part of an individual set (e.g., module set I), not including its mirrored counterpart (e.g., module set II).

In one or more examples, conveying module 102 includes first star-wheel 122, metering screw 124 and second star-wheel 126. Orienting module 104 includes third star-wheel 150. Grouping module 106 includes track 108. Grouping module 106 includes lugs 111 (herein below referred to collectively as lugs and individually as lug). Lugs 111 are coupled to and movable along track 108. Grouping module 106 includes grippers 109 (herein below referred to collectively as grippers and individually as gripper). Grippers 109 are coupled to lugs 111 (e.g., each gripper 109 is coupled to an associated lug 111). Grouping module 106 includes servo drives 112 (herein below referred to collectively as servo drives and individually as servo drive). Lugs 111 are driven about track 108 by servo drives 112 (e.g., each lug 111 is driven by an associated servo drive 112).

System 100 offers multiple benefits over previous conveyor systems in a world that demands faster and more efficient production techniques. Examples of such benefits offered by system 100 includes, but are not limited to, faster and more convenient changeover between differing container sizes and types; faster, more reliable, and more effective methods of packaging containers into groups; and reducing factory floor space required for packaging.

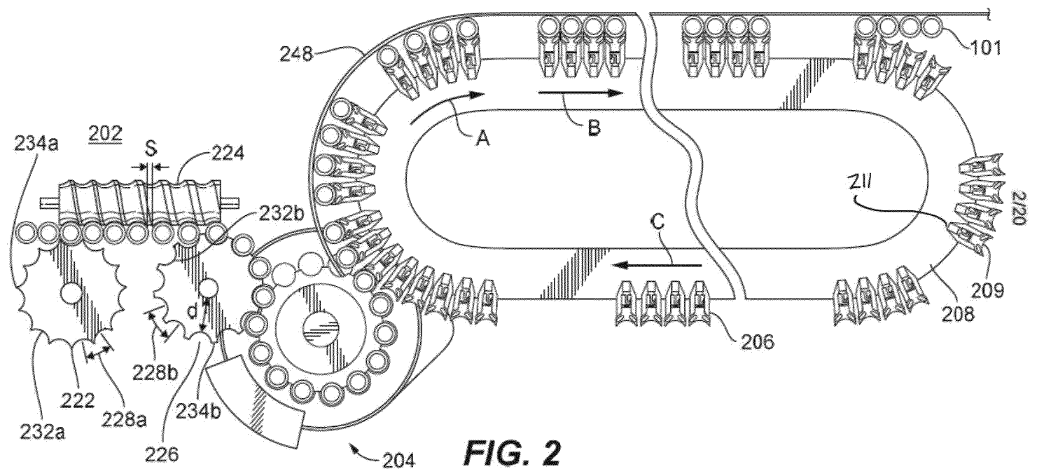

Referring now to FIG. 2, which illustrates an example of one of the sets of modules (e.g., module set I shown in FIG. 1) of system 100. The example of system 100 shown in FIG. 2 shares many common features with the example of system 100 shown in FIG. 1. In the example of system 100 shown in FIG. 2, like numerals have, where possible, been used to denote like parts, albeit with the addition of the prefix “200” to indicate that these features belong to a second example of system 100.

In one or more examples, the module set includes conveying module 202, orienting module 204, and grouping module 206. Grouping module 206 includes track 208. In one or more examples, track 208 is a single oval track.

In one or more examples, grouping module 206 includes a plurality of grippers 209 (herein below referred to collectively as grippers and individually as gripper). Grippers 209 move containers 101 along track 208.

In one or more examples, grouping module 206 includes a plurality of lugs 211 (herein below referred to collectively as lugs and individually as lug). Each gripper 209 is coupled to an associated lug 211. Lugs 211 move grippers 209 along track 208.

In one or more examples, grouping module 206 includes a plurality of servo drives (e.g., servo drives 112 as shown in FIG. 1). The servo drives of the example of system 100 shown in FIG. 2 are not visible. Each lug 211 is driven about track 208 by an associated servo drive (e.g., servo drive 112 as shown in FIG. 1).

Referring to FIGS. 1 and 2, in one or more examples, servo drive 112 is a linear servo drive. This allows for programming of a specific speed profile for each lug 111, 211 or group of lugs 111, 211, which can move separately from one another to form groups (e.g., packs 114 as shown in FIG. 1) of containers 101. Another added benefit of the horizontal oval configuration of track 108, 208 is, when power to system 100 is lost, lugs 111, 211 stay in place and are not moved by gravity and do not fall from track 108, 208.

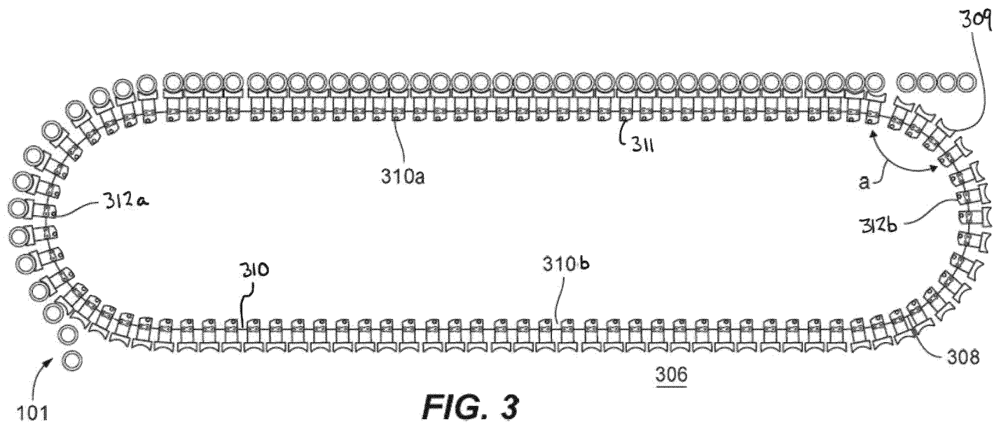

Referring now to FIG. 3, which illustrates an example of grouping module 306 of system 100. The example of system 100 shown in FIG. 3 shares many common features with the examples of system 100 shown in FIGS. 1 and 2. In the example of system 100 shown in FIG. 3, like numerals have, where possible, been used to denote like parts, albeit with the addition of the prefix “300” to indicate that these features belong to a third example of system 100.

In one or more examples, grouping module 306 includes track 308. Track 308 is a single oval track. Grippers 309 move containers 101 along track 308. Each gripper 309 is moved about track 308 by chain 310.

In one or more examples, track 308 of grouping module 406 is a single track 308 that includes two straight sections (e.g., first straight section 310a and second straight section 310b) and two curved sections (e.g., first curved section 312a and second curved section 312b).

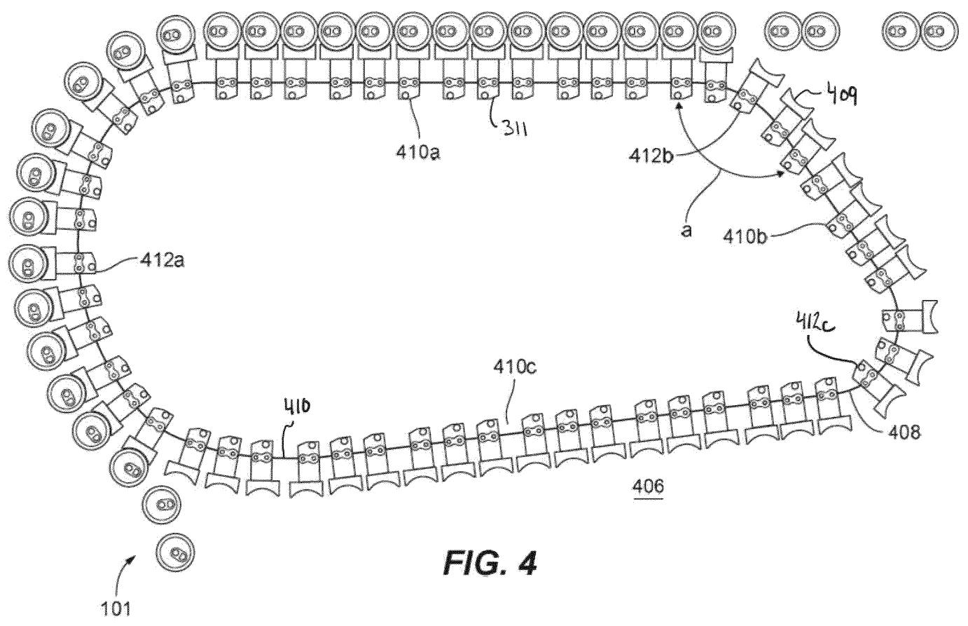

Referring now to FIG. 4, which illustrates an example of grouping module 406 of system 100. The example of system 100 shown in FIG. 4 shares many common features with the examples of system 100 shown in FIGS. 1-3. In the example of system 100 shown in FIG. 4, like numerals have, where possible, been used to denote like parts, albeit with the addition of the prefix “400” to indicate that these features belong to a fourth example of system 100.

In one or more examples, grouping module 406 includes track 408. Track 408 is a single irregular-shaped track. Grippers 409 move containers 101 along track 408. Each gripper 409 is moved about track 408 by chain 410.

In one or more examples, track 408 of grouping module 406 is a single track that includes three (e.g., at least three) straight sections 410a, 410b, 410c and three (e.g., at least two) curved sections 412a, 412b, 412c.

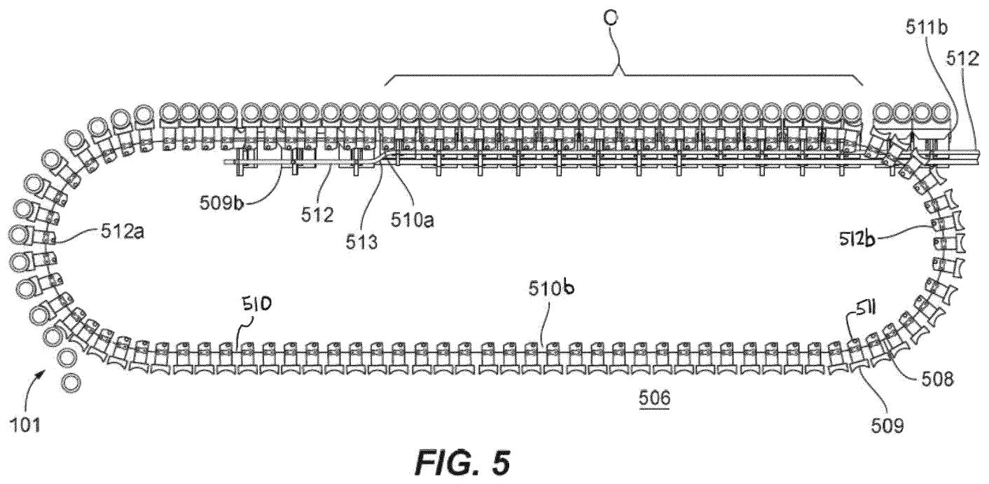

Referring now to FIG. 5, which illustrates an example of grouping module 506 of system 100. The example of system 100 shown in FIG. 5 shares many common features with the examples of system 100 shown in FIGS. 1-4. In the example of system 100 shown in FIG. 5, like numerals have, where possible, been used to denote like parts, albeit with the addition of the prefix “500” to indicate that these features belong to a fifth example of system 100.

In one or more examples, grouping module 506 includes track 508. Track 408 is a single oval track. Grippers 509 move containers 101 along track 508. Each gripper 509 is moved about track 508 by chain 510.

In one or more examples, track 508 of grouping module 506 is a single oval track that includes two straight sections 510a and 510b and two curved sections 512a, 512b.

In one or more examples, grouping module 506 also includes second track 512. Second track 512 is disposed in a vertical plane that takes the container hand-off from track 508 (also referred to as first track). Second track 512 uses a second set or second plurality of second grippers 509b (herein referred to collectively as second grippers and individually as second gripper) and second set or second plurality of second lugs 511b (herein referred to collectively as second lugs and individually as second lug) to transport containers 101 after receiving them from track 508.

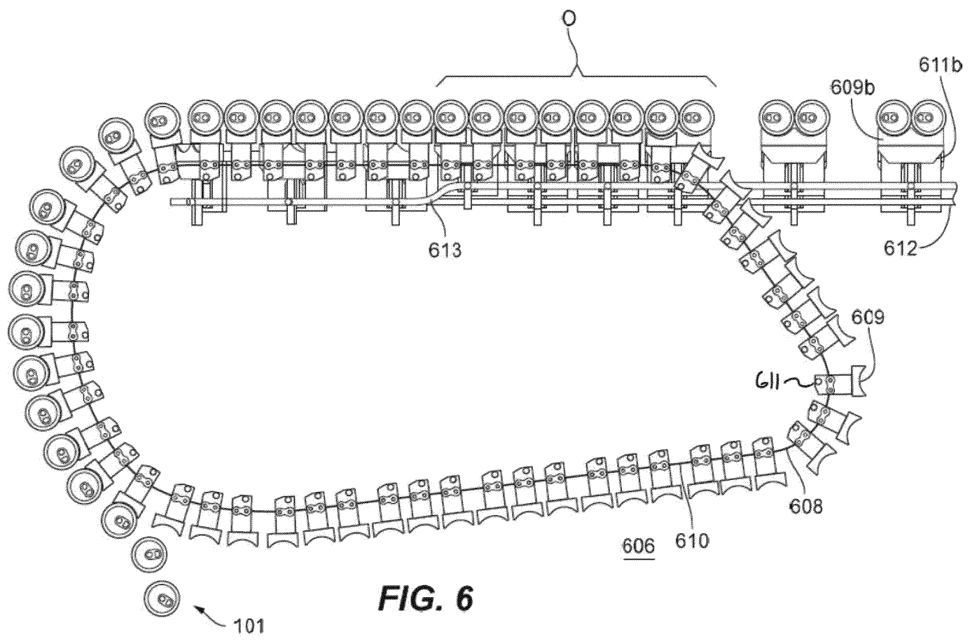

Referring now to FIG. 6, which illustrates an example of grouping module 606 of system 100. The example of system 100 shown in FIG. 6 shares many common features with the examples of system 100 shown in FIGS. 1-5. In the example of system 100 shown in FIG. 6, like numerals have, where possible, been used to denote like parts, albeit with the addition of the prefix “600” to indicate that these features belong to a sixth example of system 100.

In one or more examples, grouping module 606 includes track 608. Track 608 is a single oval track. Grippers 609 move containers 101 along track 608. Each gripper 609 is moved about track 608 by chain 610.

In one or more examples, track 608 of grouping module 606 is an irregular or oblong track (e.g., as with the example of track 408 shown in FIG. 4). In one or more examples, second track 612 is disposed in a vertical plane that receives containers 101 from track 608.

Each of the examples shown in FIGS. 1-6 include unique benefits, as will be described herein below.

The following portion of the present disclosure refers to examples of conveying module 102, 202 (e.g., as shown in FIGS. 1 and 2). It can be appreciated that any of the examples of grouping module 106, 206, 306, 406, 506, 606 can be used with any of the examples of conveying module 102, 202.

Referring now to FIGS. 1 and 2, in one or more examples, each conveying module 102, 202 receives a stream of containers 101. At this point, the stream of containers 101 typically does not have spacing between each container 101.

In one or more examples, as the stream of containers 101 reaches conveying module 102, 202, the stream meets first star-wheel 122, 222. First star-wheel 122, 222 is configured to help straighten the stream of containers 101 and feed containers 101 of the stream to metering screw 124, 224.

In one or more examples, metering screw 124, 224 creates a pitch or a predetermined spacing “S” (e.g., as shown by metering screw 224 in FIG. 2) between each of containers 101. Metering screw 124, 224 then feeds the spaced stream of containers 101 to second star-wheel 126, 226.

Referring now to FIG. 2, in one or more examples, second star-wheel 226 has a different shape than first star-wheel 222. As an example, second spacing 228b between centers of adjacent second divots 232b of second star-wheel 226 is larger than first spacing 228a between centers of adjacent first divots 232a of first star-wheel 222. As another example, second teeth 234b of second star-wheel 226 are wider that first teeth 234a of first star-wheel 222. However, the size of divots 232a, 232b of each of first and second star-wheels 222, 226 remains the same, in order to accept and handle containers 101 of the same diameter.

In one or more examples, divots 232a, 232b of star-wheels 222, 226 can be non-circular to convey non-circular containers 101, such as juice boxes, milk cartons, or motor oil.

In one or more examples, second star-wheel 226 typically has a smaller diameter and spins faster than first star-wheel 222. This combination of star-wheels 222, 226, taken alone and in combination with others, allows for a more compact footprint of conveying module 202 and of the overall system 100.

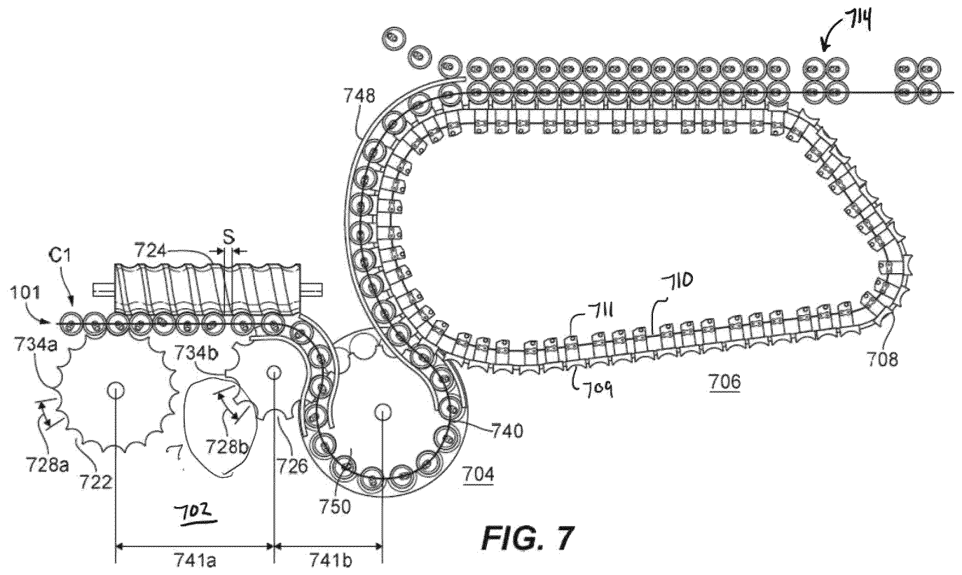

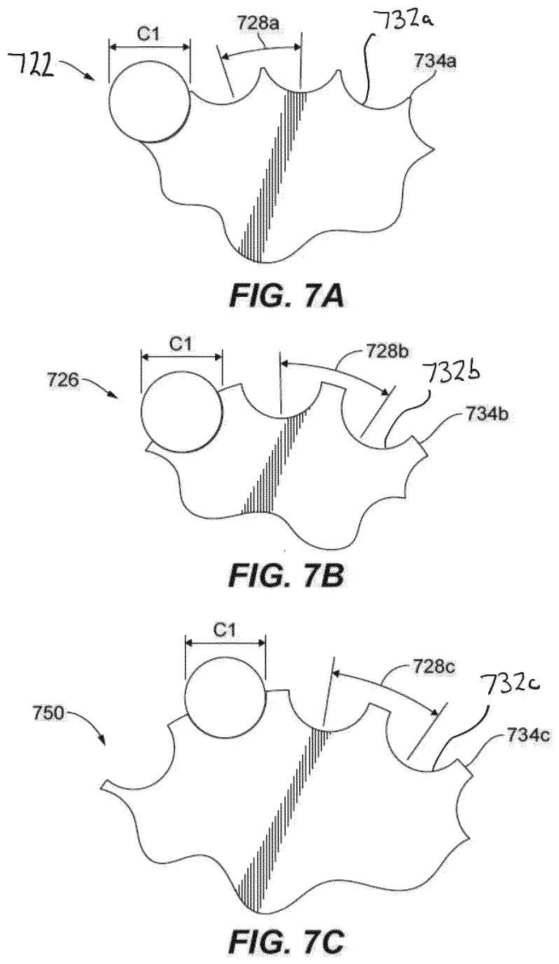

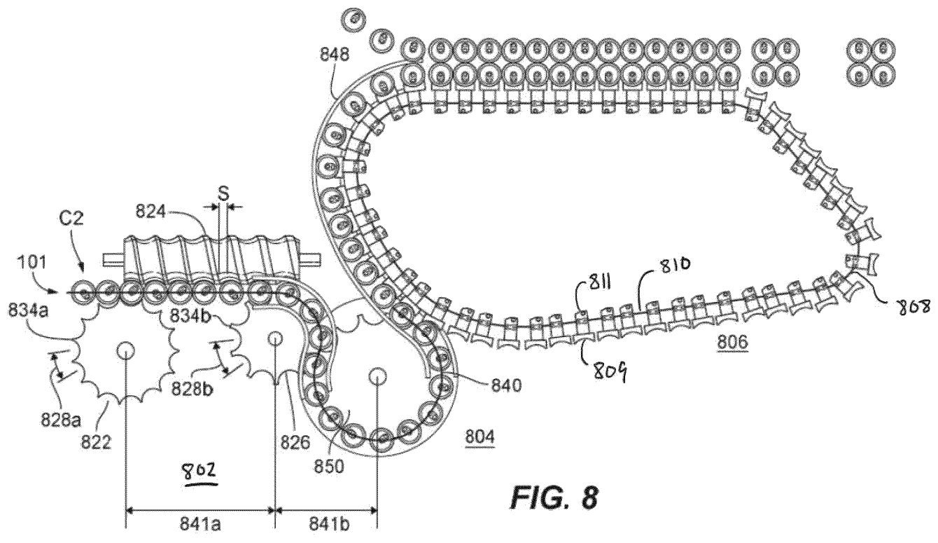

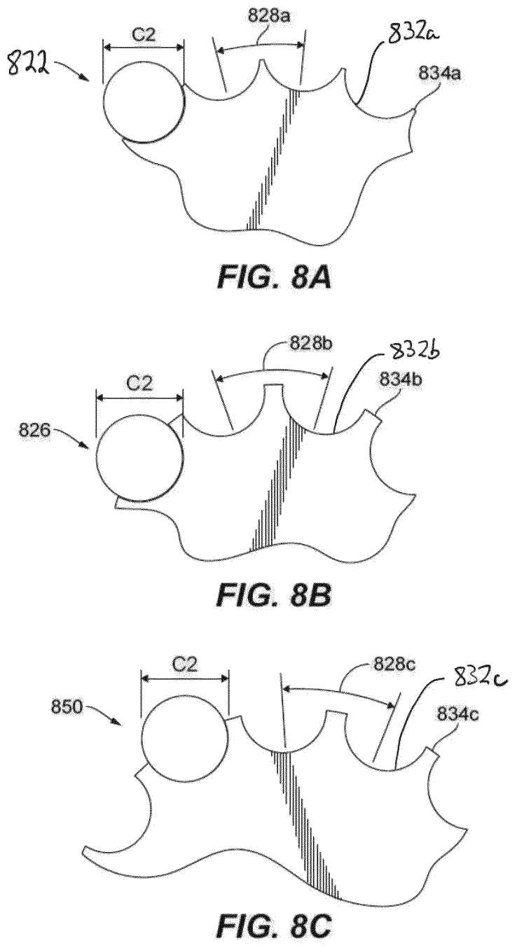

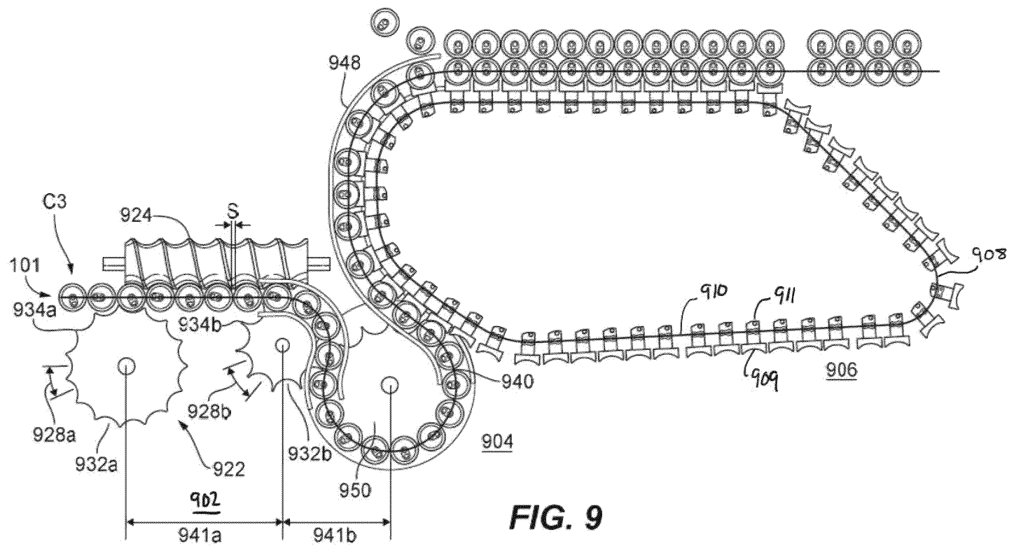

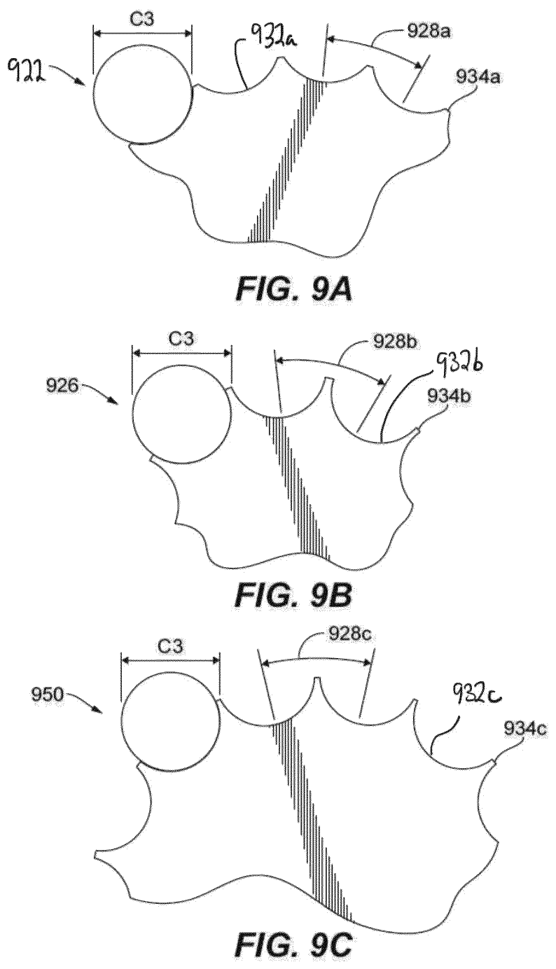

Referring now to FIGS. 7-9, which illustrate examples of system 100. The example of system 100 shown in FIG. 7 shares many common features with the examples of system 100 shown in FIGS. 1-6. In the example of system 100 shown in FIG. 7, like numerals have, where possible, been used to denote like parts, albeit with the addition of the prefix “700” to indicate that these features belong to a seventh example of the system 100. The example of system 100 shown in FIG. 8 shares many common features with the examples of system 100 shown in FIGS. 1-7. In the example of system 100 shown in FIG. 8, like numerals have, where possible, been used to denote like parts, albeit with the addition of the prefix “800” to indicate that these features belong to an eighth example of system 100. The example of system 100 shown in FIG. 9 shares many common features with the examples of system 100 shown in FIGS. 1-8. In the example of system 100 shown in FIG. 9, like numerals have, where possible, been used to denote like parts, albeit with the addition of the prefix “900” to indicate that these features belong to a ninth example of system 100.

Referring to FIG. 7, in one or more examples, the stream of containers 101 forms path 740 for the stream of containers 101 from first star-wheel 722 to track 708 of grouping module 706. Path 740 is defined by a travel path of the center of each container 101. Path 740 stays substantially the same even if the diameter of containers 101 changes (e.g., after switching out star-wheels to change container size as described above).

When comparing FIGS. 7, 8 and 9, containers 101 of FIG. 7 are smaller than containers 101 of FIGS. 8 and 9. However, path 740, 840, 940 of the centers of containers 101 is substantially the same, starting from first star-wheel 722, 822, 922 of conveying module 702, 802, 902 through third star-wheel 750, 850, 950 of orienting module 704, 804, 904. In one or more examples, path 740, 840, 940 is maintained by swapping-out first star-wheel 722, metering screw 724, second star-wheel 726 and third star-wheel 750 for a corresponding one of these parts (e.g., first star-wheel 822, 922; metering screw 824, 924; second star-wheel 826, 926; and third star-wheel 850, 950).

In one or more examples, first star-wheel 722, metering screw 724, second star-wheel 726 and third star-wheel 750 may be swapped out for corresponding parts, for example, the corresponding parts having the same number of teeth 734a, 734b, 734c and divots 732a, 732b, 732c (e.g., as shown in FIGS. 7A-7C), but deeper and wider divots 732a, 732b, 732c, and thinner teeth 734a, 734b, 734c (e.g., for larger containers 101 having a larger diameter C1) or thicker teeth 734a, 734b, 734c and narrower divots 732a, 732b, 732c (e.g., for smaller containers 101 having a smaller diameter C1).

FIGS. 7A-7C illustrate details of examples of each of the star-wheels 722, 726, 750. FIGS. 8A-8C illustrate details of examples of each of star-wheels 822, 826, 850. The examples of star-wheels 822, 826, 850 shown in FIGS. 8A-8C share many common features with the examples of star-wheels 722, 726, 750 shown in FIGS. 7A-7C. In the examples of star-wheels 822, 826, 850 shown in FIGS. 8A-8C, like numerals have, where possible, been used to denote like parts, albeit with the addition of the prefix “800” to indicate that these features belong to another example. The examples of star-wheels 922, 926, 950 shown in FIGS. 9A-9C share many common features with the examples of star-wheels 722, 726, 750 shown in FIGS. 7A-7C and the examples of star-wheels 822, 826, 850 shown in FIGS. 8A-8C. In the examples of star-wheels 922, 926, 950 shown in FIGS. 9A-9C, like numerals have, where possible, been used to denote like parts, albeit with the addition of the prefix “900” to indicate that these features belong to another example.

In one or more examples, first star-wheel 722, metering screw 724, second star-wheel 726 and third star-wheel 750 (e.g., shown in FIGS. 7 and 7A-7B) can be interchanged, as needed, with first star-wheel 822, metering screw 824, second star-wheel 826 and third star-wheel 850 (e.g., shown in FIGS. 8 and 8A-8C) or with first star-wheel 922, metering screw 924, second star-wheel 926 and third star-wheel 950 (e.g., shown in FIGS. 9 and 9A-9C).

Referring again to FIG. 7, in one or more examples, an axis on which each of star-wheels 722, 726, 750 rotates stays the same after interchanging star-wheels 722, 726, 750. Further, first distances 741a between first star-wheel 722 and second star-wheel 726 and second 741b between second star wheel 726 and third star-wheel 750 stay the same after interchanging star-wheels 722, 726, 750, for example, with the star-wheels 822, 826, 850 (e.g., shown in FIGS. 8 and 8A-8C) or with star-wheels 922, 926, 950 (e.g., shown in FIGS. 9 and 9A-9C), which are labeled 841a and 841b in FIGS. 8 and 941a and 941b in FIG. 9.

In one or more examples, star-wheels 722, 726, 750, 822, 826, 850, 922, 926, 950 are left on the same vertical axels and metering screw 724, 824, 924 is left on the same horizontal axel. This allows system 100 to be easily changed for an infeed container 101 with a different diameter (e.g., different can diameter C1 as shown in FIGS. 7-9).

As seen in FIGS. 7-9, path 740, 840, 940 of containers 101, after orienting module 704, 804, 904, is different from FIG. 7 to FIG. 8 to FIG. 9. In previously used systems, the placement of each module differs from FIG. 7 to FIG. 8 to FIG. 9, which, in turn, required more movement of modules and lengthier changeover times between different sized and/or shaped containers 101. System 100 disclosed herein saves time in changeovers (e.g., for different can sizes) and reduces the possibility of errors in those changeovers because less parts must be moved to accommodate differing parts.

Referring again to FIGS. 7-9, in one or more examples, as each container 101 passes second star-wheel 726, 826, 926, container 101 is fed to orienting module 704, 804, 904.

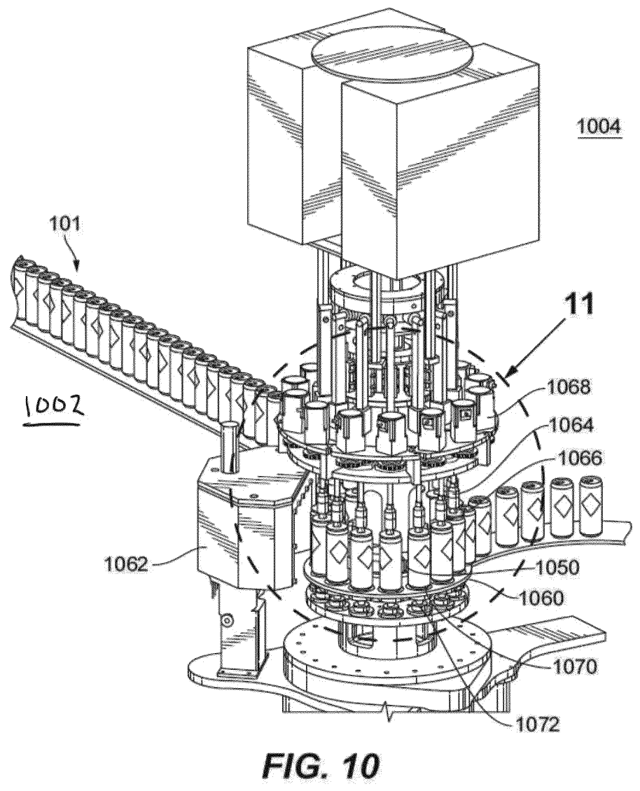

Referring now to FIG. 10, which illustrates an example of orienting module 1004. Orienting module 1004 is an example of the any of orienting modules 104, 204, 704, 804, 904 (e.g., as shown in FIGS. 1, 2, 7, 8 and 9).

In one or more examples, orienting module includes base 1060. Base 1060 supports the incoming containers 101. Generally, base 1060 is vertically stationary and is configured to rotate with containers 101 when containers 101 are rotated by third star-wheel 1050.

In one or more examples, orienting module 1004 includes camera 1062. Camera 1062 is located to the side of base 1060. Camera 1062 is configured for scanning container 101 entering and/or being oriented by orienting module 1004.

In one or more examples, orienting module 1004 includes a plurality of turning members 1064 (e.g., herein referred to collectively as turning members and individually as turning member). Each of turning members 1064 is moveably positioned above base 1060. Turning members 1064 contact and turn containers 101.

In one or more examples, orienting module 1004 includes a processor (not shown). The processor is operatively connected to camera 1062. The processor is adapted (e.g., operable or programmed) to analyze an initial orientation of containers 101 (e.g., before they are properly oriented).

In one or more examples, it is considered that camera 1062 is required to scan every single container 101. In one or more examples, it is considered that camera 1062 is only required to scan every second, or third, or fourth container 101.

Depending, for example, on downstream packaging steps and/or client specifications, each and every container 101 might be required to face the same direction. After the incoming (e.g., initial) orientation of containers 101 has been analyzed, the processor computes a necessary correction. Each container 101 may need a different correction from another container 101 because the incoming orientation could be different and/or because a final (e.g., desired) orientation may need to be different for each container 101.

In one or more examples, multiple containers 101 can be used to create a single large graphic when placed adjacent to each other within the package. Adjacent containers 101 within one package can have a different orientation showing a different graphic or portion of a graphic to a customer. Alternatively, adjacent containers 101 can form one large graphic seen across multiple containers. For instance, the graphic “CANS” can consist of four containers. Each container 101 can be showing either a ‘C’, an ‘A’, an ‘N’ or an ‘S’.

In one or more examples, third star-wheel 1050 of orientation module 1004 (e.g., may also referred to as orientation module star-wheel or orientation star-wheel) is positioned above rotatable base 1060 to help secure containers 101 as they rotate past camera 1062. As containers 101 move past camera 1062, third star wheel 1050 helps guide them and provides further stability as containers 101 get oriented.

In one or more examples, third star-wheel 1050 of orienting module 1004 has the same spacing between centers of adjacent divots as the second star-wheel (not shown in FIG. 10) of conveying module 1002, as well as the same tooth thickness. In one or more examples, it may be important to maintain spacing between each container 101 so that camera 1062 is able to properly identify the incoming orientation of each container 101. Without spacing between each container 101, adjacent containers 101 may be recognized as a single item by camera 1062 and may not be able to transmit required information to the processor.

Referring still to FIG. 10, in one or more examples, each turning member 1064 corresponds to one container 101. In order to turn each container 101, turning member 1064 moves down in order to come into contact with container 101. As turning member 1064 moves down, disk 1066, located on the bottom of each turning member 1064, contacts a top of each container 101, for example, when turning member 1064 actuates from a retracted position to a deployed position. When disk 1066 comes in contact with each container 101, each turning member 1064 rotates each container 101 a necessary amount to place container 101 in the desired orientation.

In one or more examples, disk 1066 of turning member 1064 is deformable such that disk 1066 can conform to a contour of at least a portion of an upper end of container 101 when turning member 1064 actuates from a retracted position (e.g., as shown in FIG. 11) to a deployed position (e.g., as shown in FIG. 10).

In one or more examples, a plurality of surfaces 1070 (herein referred to collectively as surfaces and individually as surface) is located within base 1060. Each of surfaces 1070 corresponds to one of turning members 1064 and to one of containers 101. Surfaces 1070 are also operatively connected to the processor (not shown) and are programmed to turn the same direction and the same amount as each of turning members 1064. Thus, containers 101 are turned evenly from the top and from the bottom, further ensuring stability during turning.

In one or more examples, motor 1072 for each of surfaces 1070 is located below the top surface of base 1060. The particular orientation, with moving turning members 1064 above containers 101 and a vertically stationary surface 1070 below the containers, allows for a smaller motor and smaller turning turret, since each container 101 does not need to be moved vertically. Once containers 101 are properly oriented, containers 101 are moved to the grouping module (not shown in FIG. 10).

In one or more examples, each one of surfaces 1070 is or takes the form of a rotatable disk that includes an upper disk-surface that is flush with an upper base-surface of base 1060. In one or more examples, motor 1072 is configured to rotate surface 1070.

Referring now to FIG. 11, which illustrates an example of a portion of orientation module 1104. The example of orientation module 1104 depicts a subsequent view in which it is possible to appreciate the now oriented containers 101a, which were previously oriented in different directions, as well as the now retracted turning members 1164a, which were previously in contact with the tops of containers 101. The example of orientation module 1104 shown in FIG. 11 shares many common features with the example of orientation module 1004 shown in FIG. 10. In the example of orientation module 1104 shown in FIG. 11, like numerals have, where possible, been used to denote like parts, albeit with the addition of the prefix “1100” to indicate that these features belong to another example of the orientation module.

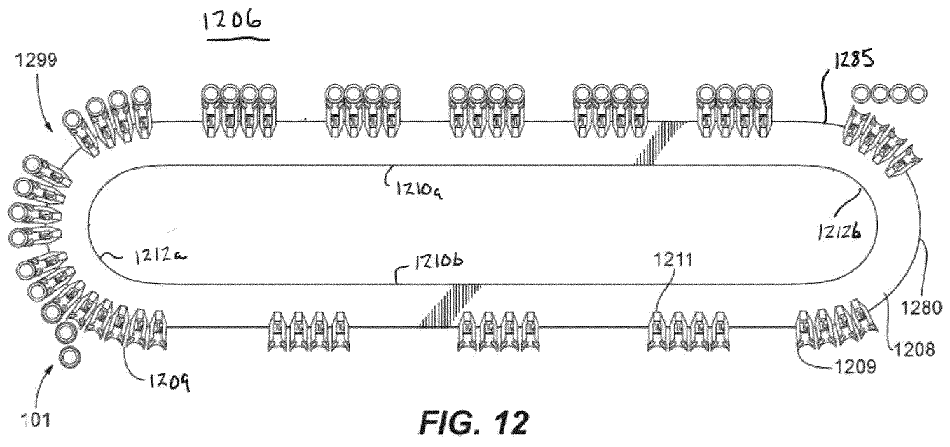

Referring now to FIG. 12, which illustrates an example of grouping module 1206. The example of grouping module 1206 shown in FIG. 12 shares many common features with the examples of grouping module 106, 206, 306, 406, 506, 606, 706, 806, 906 shown in FIGS. 1-7, 8 and 9. In the example of grouping module 1206 shown in FIG. 12, like numerals have, where possible, been used to denote like parts, albeit with the addition of the prefix “1200” to indicate that these features belong to another example of the grouping module.

In one or more examples, after containers 101 are oriented within the orienting module (e.g., not shown in FIG. 12), the stream of containers 101 is passed the orienting module. Grouping module 1206 is responsible for grouping a necessary number of containers 101 together (e.g., to begin forming packs of containers 101 for subsequent packaging), while at the same time ensuring that the orientation of each individual container 101 remains unchanged from the orientation that was received from the orienting module. As described above, a number of possibilities are presented for taking the stream of containers 101 and grouping them while ensuring that the desired orientation is maintained.

FIG. 12 illustrates an example of grouping module 1206 (e.g., as previously depicted in the example of the grouping module 206 shown in FIG. 2). Grouping module 1206 includes track 1208. Track 1208 is single oval track and is oriented in a horizontal plane. Grippers 1209, which push the containers 101 along track 1208, are individually attached to lugs 1211. In one or more examples, each lug 1211 is actuated by the linear servo drive (not shown in FIG. 12). The linear servo drive (e.g., servo drive 112 shown in FIG. 1) allows for programming an individual lug 1211 or groups of lugs 1211 speed profiles along track 1208 for lugs 1211 to follow.

As containers 101 are circulated from the orienting module to grouping module 1206, lugs 1211 move attached grippers 1209 in place to receive containers 101. Lugs 1211 are arranged prior to picking up containers 101 in queuing section 1280 and accelerate around first curved portion 1212a of track 1208 once a desired group of containers 101 (e.g., in this case it is four containers 101) have been contacted in order to create gap 1299 between the group and the next group of containers 101, while maintaining the desired orientation of containers 101 of the group of containers 101.

Once the group of containers 101 has reached first straight section 1210a of track 1208, the group of containers 101 travel at a constant speed. At this point, various packaging steps can take place. Each formed group of containers 101 can meet a group from the mirrored set of modules (e.g., module set II shown in FIG. 1) to make a single pack (e.g., pack 114 as shown in FIG. 1), such as an eight-pack, a four-pack, and the like.

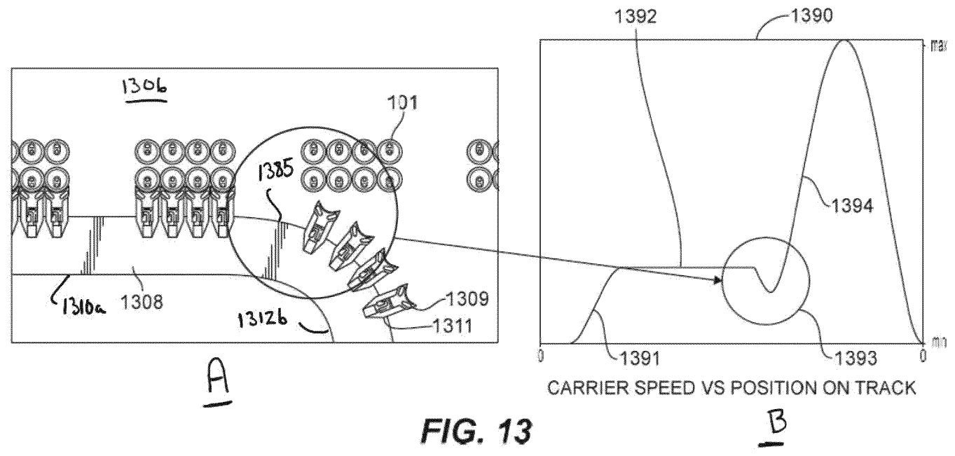

Referring now to FIG. 13A, which illustrates an example of a portion of grouping module 1306. The example of grouping module 1306 shown in FIG. 13 shares many common features with the examples of grouping module 106, 206, 306, 406, 506, 606, 706, 806, 906, 1206 shown in FIGS. 1-7, 8, 9 and 12. In the example of grouping module 1306 shown in FIG. 13, like numerals have, where possible, been used to denote like parts, albeit with the addition of the prefix “1300” to indicate that these features belong to another example of the grouping module.

In one or more examples, as lugs 1311 travel around track 1308, lugs 1311 follow a programmed speed profile. This allows any plurality of lugs 1311 to be arranged together to form a desired group of lugs 1311 (e.g., two together, three together, etc.). After lugs 1311 and grippers 1309 have reached the end of the first straight section 1310a of the track 1308, lugs 1311 and grippers 1309 peel away from containers 101, for example, at location 1385 of track 1308.

In one or more examples, a method used to peel away grippers 1309 and lugs 1311 is by slowing down grippers 1309 and lugs 1311 to allow containers 101 to keep moving forward at the point where first straight section 1310a of the track 1308 turns to second curved portion 1312b of the track 1308. This speed profile allows for gripper 1309 and container 101 to gain separation from each other before gripper 1309 changes directions, thus, preventing grippers 1309 from shifting, turning, or otherwise disturbing containers 101. After grippers 1309 are free of containers 101, they accelerate around the rest of second curved portion 1312b of track 1308 and the second straight portion (not shown in FIG. 13) of track 1308 to join lugs 1311 in the queuing section (e.g., queuing section 1280 shown in FIG. 12).

Referring now to FIG. 13B, which illustrates a graphical representation of the velocity profile 1390 for the lug (e.g., lug 1311 shown in FIG. 13A) and the gripper (e.g., gripper 1309 shown in FIG. 13A), as described above. The profile 1390 includes acceleration portion 1391, in which lug 1311 and, thus, gripper 1309 is accelerated immediately after contacting the last container 101 in the intended group of containers 101 (e.g., the second in the package of two and the third in a package of four). Acceleration portion 1391 allows the group of lugs 1311 to produce the gap (e.g., gap 1299 shown in FIG. 12) from the next group of lugs 1311. Afterwards the profile 1390 includes constant speed portion 1392, in which containers 101 are moved along at a constant speed while packaging steps are performed on containers 101. Afterwards, the profile includes a deceleration portion 1393, in which lugs 1311 and grippers 1309 are decelerated (e.g., slowed down) as the containers 101 are moved away by another conveyor or lug and carrier combination (e.g., as described above) to drop off containers 101 smoothly without disturbing them. After the containers 101 are dropped off by grippers 1309, the profile 1390 includes a second acceleration portion 1394, in which lugs 1311 and grippers 1309 accelerate to the highest velocity to return to the queuing section (e.g., queuing section 1280 shown in FIG. 12) before picking up another container 101.

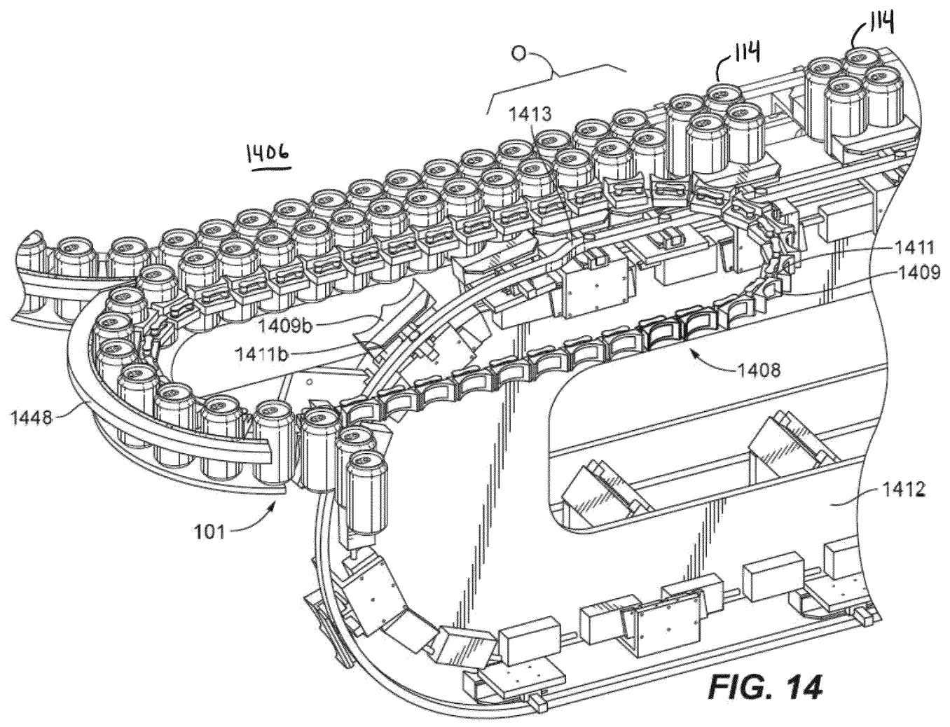

Referring now to FIG. 14, which illustrates an example of a portion of system 100. The example of system 100 shown in FIG. 14 shares many common features with the examples of system 100 shown in FIGS. 1-7, 8, 9 and 10-13. In the example of system 100 shown in FIG. 14, like numerals have, where possible, been used to denote like parts, albeit with the addition of the prefix “1400” to indicate that these features belong to another example of system 100.

In one or more examples, lugs 1411 are each attached and driven by a linear chain (not shown in FIG. 14). Lugs 1411 and containers 101 travel at a constant velocity around track 1408. In one or more examples, system 100 conveys the stream of containers 101 to a downstream packaging station or to set of second lugs 1411b and second grippers 1409b that move along second track 1412 and that would produce the groups of containers 101.

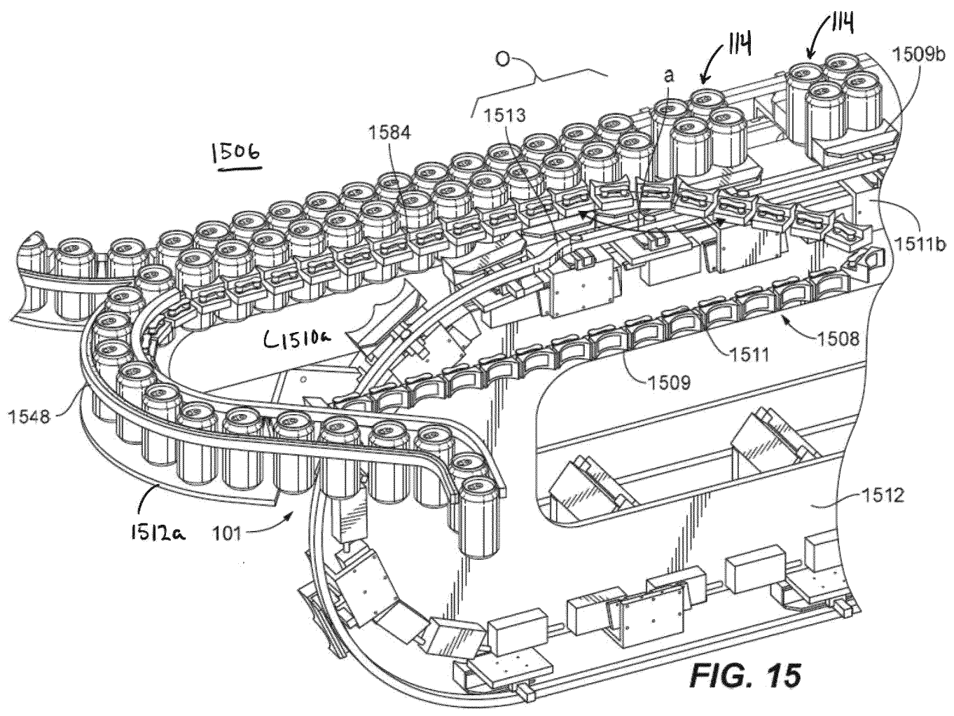

Referring now to FIG. 15, which illustrates an example of a portion of system 100. The example of system 100 shown in FIG. 15 shares many common features with the examples of system 100 shown in FIGS. 1-7, 8, 9 and 10-14. In the example of system 100 shown in FIG. 15, like numerals have, where possible, been used to denote like parts, albeit with the addition of the prefix “1500” to indicate that these features belong to another example of system 100.

In one or more examples, track 1508 is horizontal but not strictly oval in shape. In one or more examples, track 1508 is skewed at one point, for example, at location “a”. The oblong shape allows for a smoother departure of grippers 1509 from each of containers 101, since the turning angle of grippers 1509 is not as sharp. This may decrease the chances of gripper 1509 shifting container 101 as it peels away.

Each of the examples shown in FIGS. 14 and 15 can be paired with the second track (e.g., second track 1412 shown in FIG. 14 and second track 1512 shown in FIG. 15), which is responsible for receiving containers 101 from the linear chain and grouping them, again while not disturbing and disorienting containers 101.

Referring to FIG. 15, in one or more examples, grouping module 1506 include second track 1512 to move second lugs 1511b and second grippers 1509b after receiving containers 101 from track 1508. Second grippers 1509b group containers 101 into packs 114 and move packs 114 along also without changing the orientation of each container 101. While first grippers 1509 and first lugs 1511 move about the horizontal plane, second grippers 1509b and second lugs 1511b move about a vertical plane. Further, second track 1512 follows an oval but includes a horizontal protuberance 1513, which forces each second lug 1511b and attached second gripper 1509b towards the container 101.

In one or more examples, second track 1512 can include a linear motor servo drive (not shown) to actuate each of second lugs 1511b along second track 1512. Second lugs 1511b and second grippers 1509b of second track 1512 are positioned below grippers 1509 and lugs 1511 of track 1508 when both sets contact container 101. This allows system 100 to handle taller containers 101.

In one or more examples, track 1508 (e.g., first track) and second track 1512 partially overlap each other in an area indicated in FIG. 15 by reference the letter “O” and are partially aligned in the same direction, such that grippers 1509 of track 1508 and second grippers 1509b of second track 1512 contact container 101 at the same time and for a period of time in area “O” as track 1508 hands containers 101 off to second track 1212. The overlap of the tracks also allows for a more compact floor space arrangement because two vertical or two horizontal tracks would not be able to overlap without having to move container 101 vertically.

In one or more examples, during handing off of container 101 from gripper 1509 to second gripper 1509b, container 101 is simultaneously driven by other containers 101 of the stream of containers 101, for example, by second grippers 1509b along a straight path of track 1508. Grippers 1509 are withdrawn as they peel away from contacting container 101 of the stream of containers 101.

In one or more examples, gripper 1509 and second gripper 1509b drive the respective container 101 at the same velocity when both are in contact with container 101. This arrangement allows for a smooth transition from containers 101 being pushed along by lugs 1511 and grippers 1509 to later containers 101 being pushed along by second lugs 1511b and second grippers 1509b.

In one or more examples, as lugs 1511 follow track 1508 and are connected to corresponding grippers 1509, curved guide 1548 is placed at a location where grippers 1509 pick up containers 101 from the orienting module (not shown in FIG. 15) and follows track 1508 to the first straight section 1510a. Guide 1548 helps bias containers 101 against a body of each one of grippers 1509.

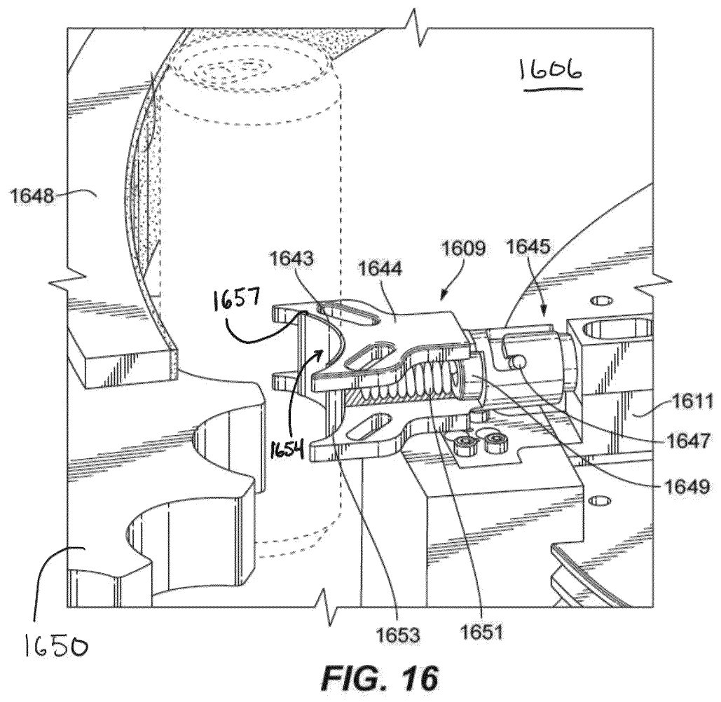

Referring now to FIG. 16, which illustrates an example of gripper 1609. Gripper 1609 is an example of any of the examples of gripper 109, 209, 309, 409, 509, 609, 709, 809, 909, 1209, 1309, 1409 shown in FIGS. 1-7, 8, 9, 12, 13A, 14 and 15. FIG. 16 depicts an example of gripper 1609 used by an example of grouping module 1606.

In one or more examples, gripper 1609 includes gripper body 1644. Gripper body 1644 partially surrounds and drives a corresponding container 101 along the track (not shown in FIG. 16). In one or more examples, gripper body 1644 includes receiving end 1643 and locking end 1645, opposite receiving end 1643. In one or more examples, gripper body 1644 is coupled to lug 1611 at or by locking end 1645.

In one or more examples, coupling 1647 is used to couple gripper body 1644 and lug 1611 together. In one or more examples, coupling 1647 is located on locking end 1645 of gripper body 1644. Coupling 1647 may be any suitable type or style of mechanical coupling or connector assembly, such as a two-part interconnection assembly. In an example, coupling 1647 is a bayonet style lock. This coupling style allows for an easy changeover of gripper 1609 depending, for example, on the size and/or shape of container 101.

In one or more examples, each lug 1611 includes shaft 1649. Shaft 1649 extends horizontally and is configured to connect to coupling 1647 at locking end 1645 of gripper body 1644.

In one or more examples, dampener 1651 is positioned within or is otherwise coupled to or integrated with gripper body 1644. In one or more examples, dampener 1651 is or takes the form of a spring, a dash pot, a cushion, or the like, which allows for smoothly reacting to container 101 that is out of place and also acts as a shock absorber in order to not damage container 101 when gripper 1609 comes into contact with container 101.

In one or more examples, receiving end 1643 of gripper 1609 includes concave gripper surface 1657. Concave gripper surface 1657 is configured (e.g., suitable sized and shaped) to partially surround container 101. For example, concave gripper surface 1657 has a radius of curvature that is approximately equal to that of container 101 such that receiving end 1643 suitable accepts and handles container 101 having a matching diameter.

In one or more examples, insert 1653 is placed in a concave portion of receiving end 1643 (e.g., applied to or on concave gripper surface 1657) of gripper body 1644, such that, when insert 1652 comes in contact with container 101, insert 1653 of receiving end 1643 helps keep container 101 oriented in the proper position and/or orientation.

In one or more examples, insert 1653 includes a material having a higher coefficient of friction than gripper body 1644, such as of receiving end 1643. In one or more examples, insert 1653 also has a higher coefficient of friction than a contact surface of guide 1648. This combination of friction coefficients allows gripper 1609 to slide container 101 along guide 1648 without container 101 changing an orientation or slipping from gripper 1609, especially along the curved portion of the track (not shown in FIG. 16) where lug 1611 and gripper 1609 are accelerating.

In one or more examples, gripper 1609 utilizes vacuum (e.g., negative pressure) to hold container in contact with receiving end 1643 of gripper 1609. In an example, gripper 1609 includes vacuum application device 1654 that is configured to selectively apply vacuum to a portion of a surface of container 101 when container 101 is in contact with receiving end 1643 of gripper 1609. In one or more examples, vacuum application device 1654 may include, but is not limited to, a suction cup (e.g., a flexible bellows suction cup), a vacuum port, or other suitable vacuum mechanism.

Generally, vacuum application device 1654 is located on receiving end 1643, such as on, being formed through or extending from concave gripper surface 1657. In this manner, concave gripper surface 1657 appropriately positions container 101 for contact with vacuum application device 1654 during vacuum coupling of gripper 1609 to container 101. In one or more examples, as gripper 1609 and container 101 move past guide 1648, insert 1653 and/or vacuum application device 1654 maintain the orientation of the container 101.

In one or more examples, insert 1653 can be an adhesive strip, such as fugitive glue. This type of adhesive allows gripper 1609 to keep container 101 from rotating, but also allows gripper 1609 to peel away at the necessary stage without affecting the orientation of container 101.

Referring now to FIG. 17, which illustrates an example of a portion of system 100. The example of system 100 shown in FIG. 17 shares many common features with the examples of system 100 shown in FIGS. 1-7, 8, 9 and 10-16. In the example of system 100 shown in FIG. 17, like numerals have, where possible, been used to denote like parts, albeit with the addition of the prefix “1700” to indicate that these features belong to another example of system 100.

In one or more examples, system 100 includes or can be used in conjunction with packaging apparatus 1795. Packaging apparatus 1795 partially overlaps with track 1708 and is configured to overlay packaging 1796 (e.g., cardboard as shown in FIG. 17 or plastic wrap), while grippers 1709 are still in contact with containers 101. This arrangement further ensures that containers 101 keep their intended orientation all the way through the packaging process.

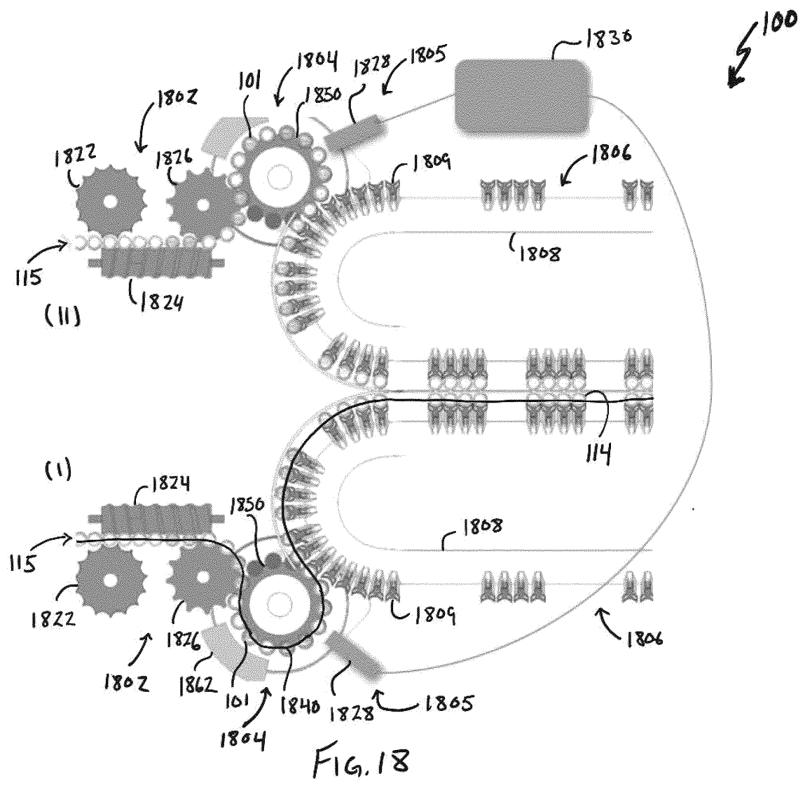

Referring now to FIG. 18, which illustrates an example of a portion of system 100. The example of system 100 shown in FIG. 18 shares many common features with the examples of system 100 shown in FIGS. 1-17. In the example of system 100 shown in FIG. 18, like numerals have, where possible, been used to denote like parts, albeit with the addition of the prefix “1800” to indicate that these features belong to another example of system 100.

The example of system 100 shown in FIG. 18 includes two sets of modules (e.g., first module set I and second module set II as previously depicted in the example shown in FIG. 1). In one or more examples, each set of modules (e.g., the first module set I and/or the second module set II) includes conveying module 1802, orienting module 1804 and grouping module 1806.

FIG. 18 depicts first star-wheel 1822, second star-wheel 1826 and metering screw 1824 of conveying module 1802. Conveying module 1802 is configured to supply stream 115 of containers 101. Conveying module 1802 is also configured to guide or move each one of containers 101 of stream 115 along a portion of path 1840. Conveying module 1802 is further configured to transfer containers 101 of stream 115 to orienting module 1804.

FIG. 18 depicts third star-wheel 1850 and camera 1862 of orienting module 1804. Orienting module 1804 is configured to receive stream 115 of containers 101 (e.g., from conveying module 1802). Orienting module 1804 is also configured to guide or move each one of containers 101 of stream 115 along a portion of path 1840. Orienting module 1804 is further configured to scan and orient containers 101. For example, orienting module 1804 is configured to orient each one of containers 101 in at least one desired orientation as containers 101 travel along path 1840.

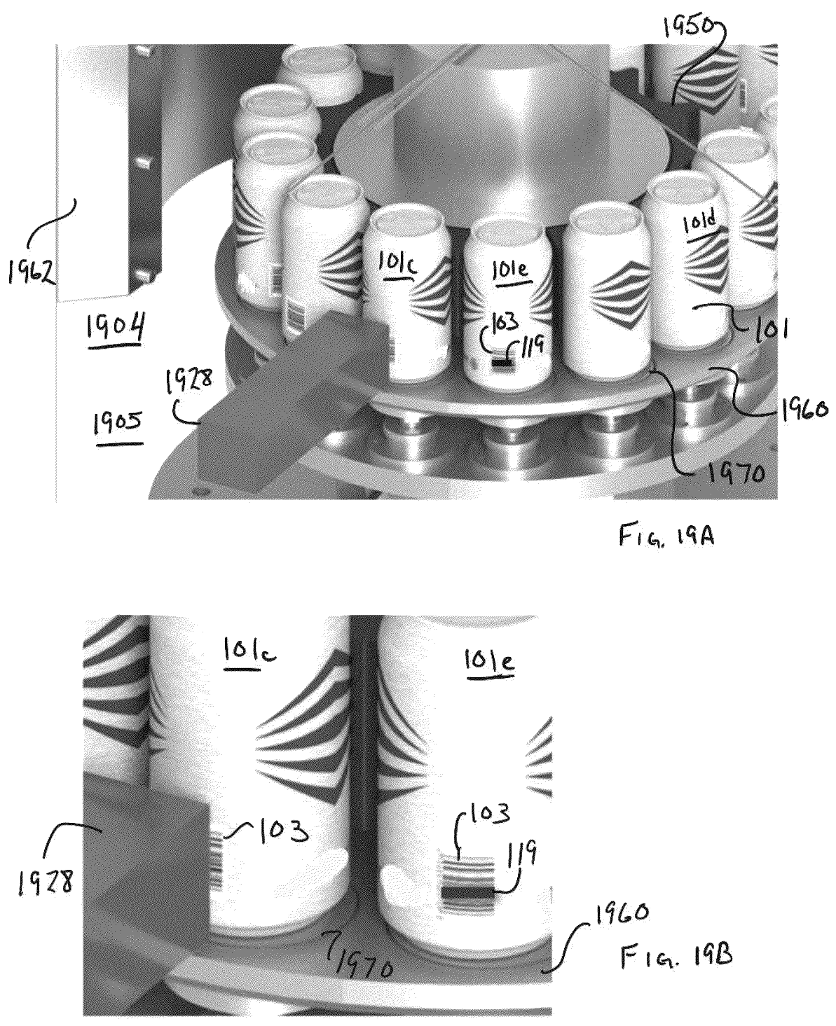

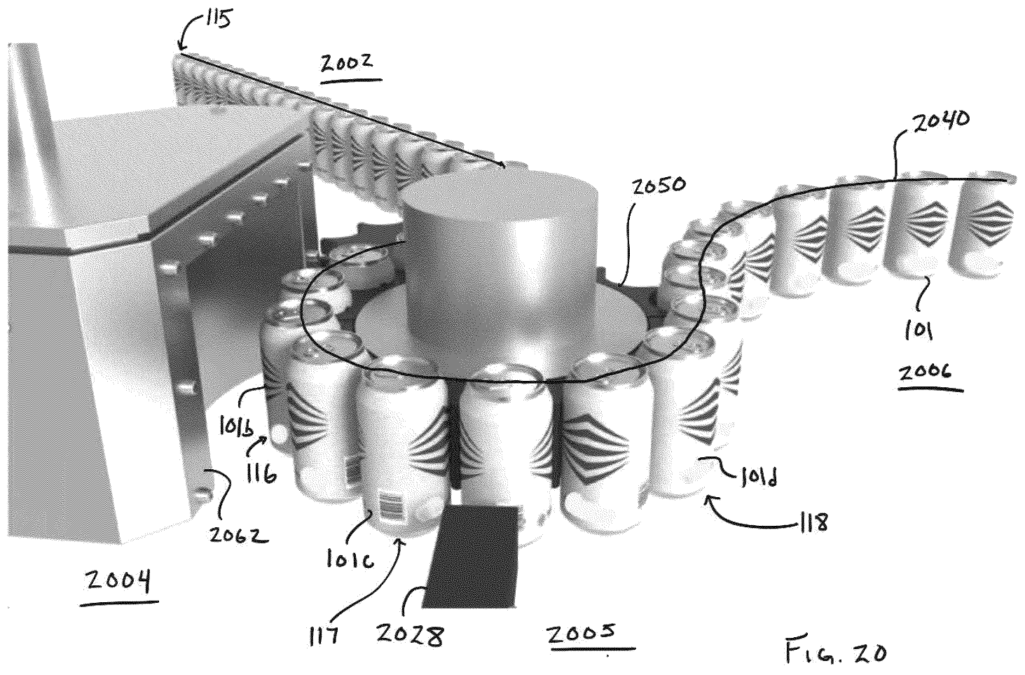

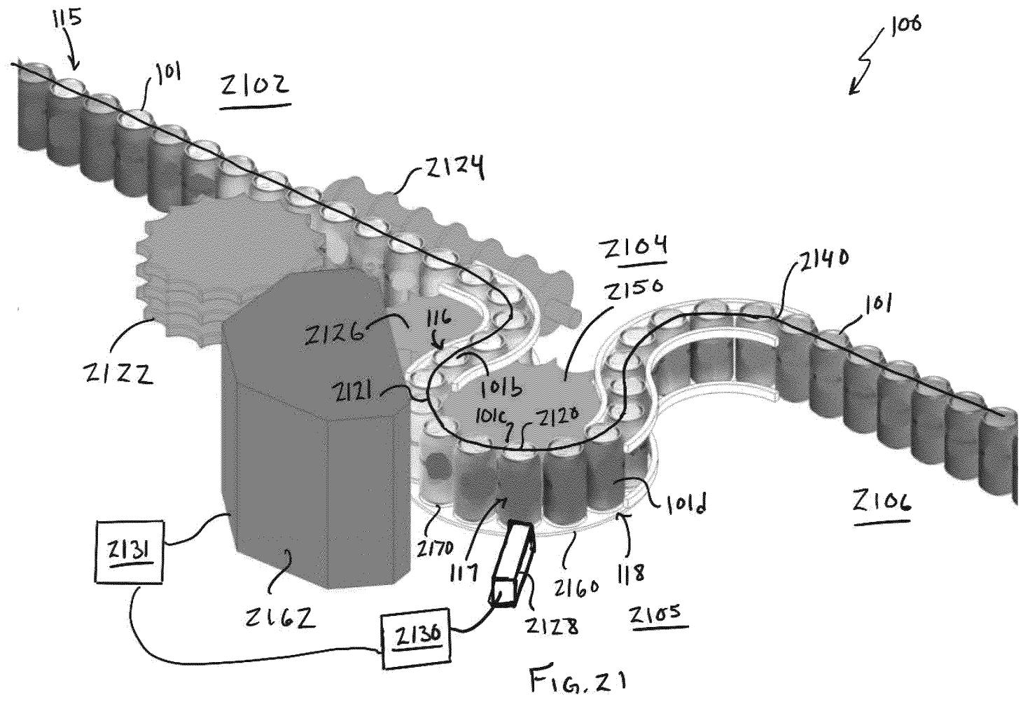

In one or more examples, each set of modules (e.g., the first module set I and/or the second module set II) also includes masking module 1805. Masking module 1805 is configured to mask or apply a mask (e.g., mask 119 as shown in FIGS. 19A-20) to at least a portion of a barcode (e.g., barcode 103 as shown in FIGS. 19A-20) of at least one container 101 of stream 115 as containers 101 travel along a portion of path 1840.

In one or more examples, masking module 1805 is situated along a portion of path 1840 between orienting module 1804 and grouping module 1806.

In one or more examples, masking module 1805 includes masking apparatus 1828. Masking apparatus 1828 is situated proximate to path 1840 of stream 115 of containers 101. Masking apparatus 1828 is configured for masking or for applying the mask (e.g., mask 119 as shown in FIGS. 19A-20) to at least a portion of the barcode (e.g., barcode 103 as shown in FIGS. 19A-20) of at least one of containers 101 as containers 101 travel along path 1840.

In one or more examples, masking module 1805 includes controller 1830. Controller 1830 is in communication with masking apparatus 1828. Controller 1830 is configured to selectively actuate masking apparatus 1828 when at least one of containers passes by masking apparatus 1828 along path 1840.

FIG. 18 depicts track 1808 and grippers 1809 of grouping module 1806. Grouping module 1806 is configured to receive containers 101 from orienting module 1804. Grouping module 1806 is also configured to guide or move each one of containers 101 of stream 115 along a portion of path 1840. Grouping module 1806 is further configured to maintain each container 101 in the desired orientation as containers 101 travel along a portion of path 1840. Grouping module 1806 is also configured to organize containers 101, while in the desired orientation (e.g., oriented containers), into groups and/or packs 114, for example, for packaging (e.g., as shown in FIG. 17).

Referring now to FIGS. 19A and 19B, which illustrates an example of a portion of system 100 and, more particularly, a portion of orienting module 1904 and a portion of masking module 1905. The example of system 100 shown in FIGS. 19A and 19B shares many common features with the examples of system 100 shown in FIGS. 1-18. In the example of system 100 shown in FIGS. 19A and 19B, like numerals have, where possible, been used to denote like parts, albeit with the addition of the prefix “1900” to indicate that these features belong to another example of system 100.

FIG. 19A depicts masking apparatus 1928 of masking module 1905, which masks at least a portion of barcode 103 (e.g., applies mask 119) to at least a portion of barcode 103. FIG. 19A also depicts camera 1962, third star-wheel 1950, base 1960, and surfaces 1970 of orienting module 1904, which properly orient at least one container 101 to a desired orientation for a masking operation performed by masking apparatus 1928.

Barcode 103 is generally applied to a surface of each one of containers 101. The term “barcode,” for example, in reference to barcode 103, refers to any visual representation of data or information, for example, in a machine-readable form (e.g., scannable by an optical scanner or barcode reader). Barcode 103 can take any suitable form and may include, but is not limited to, one-dimensional (1D) barcodes, two-dimensional (2D) barcodes (e.g., matrix barcodes or quick response (QR) codes, and the like. In one or more examples, barcode 103 is printed on the surface of container 101. In one or more examples, barcode 103 is or takes the form of a label (e.g., an adhesive label) that is applied to the surface of container 101.

For the purpose of the present disclosure, the terms “mask” and “masking,” in reference to applying a mask (e.g., mask 119) to or masking a portion of a barcode refers to, but is not limited to, blocking, obfuscating, altering, or modifying the barcode such that at least a portion of the barcode is rendered unscannable after the masking operation.

In one or more examples, masking apparatus 1928 includes or takes the form of an inkjet printer. In these examples, masking apparatus 1928 (e.g., inkjet printer) is configured to apply ink over at least a portion of barcode 103. In these examples, masking apparatus 1928 includes any operational elements, features and/or components typical for inkjet printers of the type used to print on the surface of container 101, for example, depending on the contour of the surface of container 101, such as curved surfaces of circular containers (e.g., cans or bottles), planar surfaces of square containers (e.g., boxes or cartons), or other regular or irregular surfaces of the containers. The operational elements, features and/or components of the inkjet printer may further depend on the material type of surface or the material of container 101 on which barcode 103 is situated, for example, metal containers, glass containers, paper or paperboard containers, plastic containers, barcode labels, and the like.

In one or more examples, masking apparatus 1928 includes or takes the form of a laser printer. In these examples, masking apparatus 1928 (e.g., laser printer) is configured to apply ink over at least a portion of barcode 103. In these examples, masking apparatus 1928 includes any operational elements, features and/or components typical for laser printers of the type used to print on the surface of container 101, for example, depending on the contour of the surface of container 101, such as curved surfaces of circular containers (e.g., cans or bottles), planar surfaces of square containers (e.g., boxes or cartons), or other regular or irregular surfaces of the containers. The operational elements, features and/or components of the laser printer may further depend on the material type of surface or the material of container 101 on which barcode 103 is situated, for example, metal containers, glass containers, paper or paperboard containers, plastic containers, barcode labels, and the like.

In one or more examples, masking apparatus 1928 includes or takes the form of a laser etcher or a laser engraver. In these examples, masking apparatus 1928 (e.g., laser etcher or laser engraver) is configured to remove at least a portion of barcode 103. For example, masking apparatus 1928 (e.g., laser etcher or laser engraver) melts, vaporizes, or otherwise removes material from the surface of container 101 on which barcode 103 is applied. In these examples, masking apparatus 1928 includes any operational elements, features and/or components typical for laser etchers or laser engravers of the type used to remove material from the surface of container 101, for example, depending on the contour of the surface of container 101, such as curved surfaces of circular containers (e.g., cans or bottles), planar surfaces of square containers (e.g., boxes or cartons), or other regular or irregular surfaces of the containers. The operational elements, features and/or components of the laser etcher or laser engraver may further depend on the material type of surface or the material of container 101 on which barcode 103 is situated, for example, metal containers, glass containers, paper or paperboard containers, plastic containers, barcode labels, and the like.

In other examples, masking apparatus 1928 may include or take the form of any other suitable device or mechanism that operates to mask (e.g., remove, cover, or otherwise block) a portion of barcode 103.

In any of the above examples, the controller (e.g., controller 1830 shown in FIG. 18) operates to instruct masking apparatus 1928 to apply mask 119 to at least a portion of barcode 103 (e.g., apply ink over or remove at least a portion of barcode 103) at an appropriate time as container 101 moves along the path (e.g., path 1840 shown in FIG. 18). In an example, the controller includes a processor, memory, and program instructions stored in the memory and that are executable by the processor to provide instructions to masking apparatus 1928.

Generally, masking apparatus 1928 is configured to apply mask 119 having various dimensions, depending, for example, on the extent of barcode 103 to be masked in a particular masking operation. As an example, masking apparatus 1928 applies mask 119 to a portion of barcode 103. As another example, masking apparatus 1928 applied mask 119 to an entirety of barcode 103. In one non-limiting example, mask 119 may have dimensions of approximately 2 millimeters by approximately 25 millimeters, which masks a portion of barcode 103.

In one or more examples, mask 119 is capable of being removed (e.g., a removable mask). For example, masking apparatus 1928 (e.g., inkjet printer or laser printer) may utilize and apply an ink of the type that can be removed from the surface of container 101 such that barcode 113 is uncovered and, thereby, again scannable.

Referring now to FIG. 20, which illustrates an example of a portion of system 100 and, more particularly, a portion of orienting module 2004 and a portion of masking module 2005. The example of system 100 shown in FIG. 20 shares many common features with the examples of system 100 shown in FIGS. 1-19B. In the example of system 100 shown in FIG. 20, like numerals have, where possible, been used to denote like parts, albeit with the addition of the prefix “2000” to indicate that these features belong to another example of system 100.

FIG. 20 depicts masking apparatus 2028 of masking module 2005, which masks at least a portion of barcode 103 (e.g., applies mask 119 to at least a portion of barcode 103). FIG. 20 also depicts camera 2062 and third star-wheel 2050 of orienting module 2006, which properly orient at least one container 101 to a desired orientation for a masking operation performed by masking apparatus 2028.

In one or more example, stream 115 of container 101 is moved along a portion of path 2040 and each one of containers 101 is transferred from conveying module 2002 to orienting module 2004 along path 2040. Each one of containers 101 is oriented in initial orientation 116 (e.g., initially oriented container 101b) when received by orienting module 2004. The rotational orientation of containers 101 may not be controlled as stream 115 of containers 101 are guided along a portion of path 2040 by conveying module 2002. Accordingly, initial orientation 116 of each one of containers 101 may be unknown and/or may be different when container 101 is handed off to orientating module 2004.

In one or more examples, at least one container 101 is selectively oriented in masking orientation 117 (e.g., masking oriented container 101c) relative to masking apparatus 2028 before at least the one container 101 passes by masking apparatus 2028 along path 2040. For example, at least one or each one of containers 101 is selectively rotated from initial orientation 116 (e.g., first rotational orientation) to masking orientation 117 (e.g., second rotational orientation) using orienting module 2004 before container 101 is presented to or passes by masking apparatus 2028 along path 2040.

Masking orientation 117 refers to a desired rotational orientation of container 101 such that barcode 103 is suitably situated for the masking operation using masking apparatus 2028. For example, masking orientation 117 is a rotational orientation of container 101 in which barcode 103 is facing an outward direction relative to third star-wheel 2050.

In one or more example, each one of containers 101 is then selectively oriented to packing orientation 118 (e.g., packing oriented container 101d) after containers 101 passes by masking apparatus 2028 along path 2040. For example, at least one or each one of containers 101 is selectively rotated from masking orientation 117 (e.g., second rotational orientation) to packing orientation 118 (e.g., third rotational orientation) after containers 101 pass by masking apparatus 2028 along path 2040 and before containers 101 are transferred to grouping module 2006.

Packing orientation 118 refers to a desired rotational orientation of container 101 for packaging (e.g., as shown in FIG. 17). For example, packing orientation 118 orients container 101 such that a graphic or portion of a graphic is presented in a desired direction. In one or more examples, packing orientation 118 for at least one of containers 101 is different than at least another one of containers 101.

Referring now to FIG. 21, which illustrates an example of a portion of system 100 and, more particularly, a portion of conveying module 2102, a portion of orienting module 2104 and a portion of masking module 2105. The example of system 100 shown in FIG. 21 shares many common features with the examples of system 100 shown in FIGS. 1-20. In the example of system 100 shown in FIG. 21, like numerals have, where possible, been used to denote like parts, albeit with the addition of the prefix “2100” to indicate that these features belong to another example of system 100.

FIG. 21 depicts first star-wheel 2122, metering screw 2124 and second star-wheel 2126 of conveying module 2102, which supplies stream 115 of containers 101 to orienting module 2104 in initial orientation 116. FIG. 21 also depicts masking apparatus 2128 and controller 2130 of masking module 2105, which masks at least a portion of barcode 103 (not shown in FIG. 21) of container 101. FIG. 21 further depicts camera 2162, third star-wheel 2150, base 2160 and surfaces 2170 of orienting module 2106, which properly orients at least one container 101 to masking orientation 117 for the masking operation performed by masking apparatus 2128 and subsequently orients at least one container 101 to packing orientation 118 after the masking operation.

In one or more examples, conveying module 2102 is configured to transfer stream 115 of containers 101 to orienting module 2104 in initial orientation 116. Orienting module 2004 is configured to receive stream 115 of containers 101, to guide each one of containers 101 along a portion of path 2140, and to orient at least one of containers 101 in masking orientation 117 at masking location 2120 along path 2140. Generally, masking location 2120 is a position along path 2140 at which the masking operation is performed using masking apparatus 2128. a Masking module 2105 is configured to apply mask 119 (not shown in FIG. 21) to at least a portion of barcode 103 (not shown in FIG. 21) of at least one container 101 as container 101 passes marking location 2120 along path 2140.

In one or more examples, orienting module 2104 is configured to selectively rotate at least one or each one of containers 101 from initial orientation 116 to masking orientation 117 before container 101 reaches or passes by masking location 2120 along path 2140. In one or more examples, orienting module 2104 is further configured to selectively rotate at least one or each one of containers 101 from masking orientation 117 to packing orientation 118 after container 101 passes by masking location 2120 along path 2140 and before container 101 is transferred (e.g., handed off) from orienting module 2104 to grouping module 2106.

In one or more examples, grouping module 2106 is configured to receive stream 115 of containers 101 from orienting module 2104 in packing orientation 118. As described herein above, grouping module 2106 is configured to group containers 101 in packs 114 (e.g., as shown in FIG. 18) with containers 101 in packing orientation 118. Additionally, as described herein above, grouping module 2106 is further configured to maintain each one of containers 101 in packing orientation 118 while moving containers 101 along a portion of path 2140, for example, using the grippers.

In one or more examples, barcode 103 of select ones of containers 101 may not be masked. In these examples, orienting module 2104 is further configured to selectively rotate at least one or each one of containers 101 from initial orientation 116 directly to packing orientation 118 along path 2140 before container 101 is transferred from orienting module 2104 to grouping module 2106.

In one or more examples, masking apparatus 2128 is situated proximate to path 2140 of stream 115 of containers 101. Masking apparatus 2128 is configured to apply mask 119 to at least a portion of barcode 103 of at least one of containers 101. Controller 2130 is in communication with masking apparatus 2128. Controller 2130 is configured (e.g., is adapted or operates) to selectively actuate masking apparatus 2128 when at least one container 101 is at masking location 2120 along path 2140.

In one or more examples, camera 2162 is situated to capture an image of at least one of containers 101 as at least container 101 travels along a portion of path 2140 in initial orientation 116. In one or more examples, processor 2131 is coupled to camera 2162 and is configured to analyze the image and to determine a first angle of rotation from initial orientation 116 to masking orientation 117. The turning member (e.g., turning member 1064, 1164 shown in FIGS. 10 and 11) of orienting module 2104 is configured to rotate container 101 by the first angle of rotation according to a first command from processor 2131.

In one or more examples, processor 2131 is further configured to analyze the image and to determine a second angle of rotation from masking orientation 117 to packing orientation 118. The turning member (e.g., turning member 1064, 1164 shown in FIGS. 10 and 11) of orienting module 2104 is further configured to rotate container 101 by the second angle of rotation according to a second command from processor 2131.

In one or more examples, camera 2162 is any suitable scanning system or vision system that can collect or generate data that is representative of container 101 and, more particularly, that is representative of the rotational orientation of container 101.

In one or more examples, processor 2131 is any computing device or networked system of computing devices that can analyze the data collected or generated by camera 2162. For example, processor 2131 analyzes the captured image of container 101 in initial orientation 116 (e.g., image of initially oriented container 101b) and compares the image to a group or collection of reference images that represent container 101 at a plurality of rotational orientations. Based on a correlation of the captured image with the associated reference image, processor 2131 determines initial orientation 116 of container 101. Processor 2131 then calculates the first angle of rotation needed to achieve or effectuate rotation from initial orientation 116 to masking orientation 117.

In one or more examples, processor 2131 is configured to instruct orienting module 2104 (e.g., either directly or indirectly via a controller dedicated to orienting module 2104) to rotate container 101 by the first angle of rotation. In one or more examples, processor 2131 is in communication with controller 2130 of masking module 2105 such that controller 2130 instructs masking apparatus 2128 to apply mask 119 to at least a portion of barcode 103 when container 101 is in masking orientation 117 at masking location 2120 along path 2140.

In one or more examples, processor 2131 also calculates the second angle of rotation needed to achieve or effectuate rotation from masking orientation 117 to packing orientation 118. In one or more examples, processor 2131 is configured to instruct orienting module 2104 (e.g., either directly or indirectly via a controller dedicated to orienting module 2104) to rotate container 101 by the second angle of rotation. For example, processor 2131 analyzes the captured image of container 101 in initial orientation 116 (e.g., image of initially oriented container 101b) and compares the image to a group or collection of reference images that represent container 101 at a plurality of rotational orientations. Based on a correlation of the captured image with the associated reference image, processor 2131 determines initial orientation 116 of container 101. Processor 2131 then calculates an overall angle of rotation needed to achieve or effectuate rotation from initial orientation 116 to packing orientation 118. Processor 2131 calculates the second angle of rotation based on the difference between the overall angle of rotation and the first angle of rotation.

In one or more examples, processor 2131 is adapted to analyze the image of container 101, calculate the first angle of rotation needed to achieve or effectuate rotation from initial orientation 116 to masking orientation 117, and calculate the second angle of rotation needed to achieve or effectuate rotation from masking orientation 117 to packing orientation 118 in generally the same processing step such that first angle of rotation and the second angle of rotation are determined before any selective rotation of container 101 commences.

In one or more examples, processor 2131 is adapted to analyze the image of container 101 and calculate the first angle of rotation needed to achieve or effectuate rotation from initial orientation 116 to masking orientation 117 in generally the same processing step. In one or more examples, processor 2131 is adapted to analyze the image of container 101 and calculate the second angle of rotation needed to achieve or effectuate rotation from masking orientation 117 to packing orientation 118 in a subsequent processing step such that first angle of rotation is determined before selective rotation of container 101 from initial orientation 116 to masking orientation 117 and the second angle of rotation is determined before selective rotation of container 101 from masking orientation 117 to packing orientation 118.

While image capture, correlation and analysis is provided an example method for determining or calculating the angles of rotation needed to effectuate appropriate rotation of container 101 from initial orientation 116 to masking orientation 117 and then appropriate rotation of container 101 from masking orientation 117 to packing orientation 118, in other examples, orienting module 2104 may utilize any other suitable scanning and data analysis technique or operation without limiting the scope or intended purpose of the system 100.

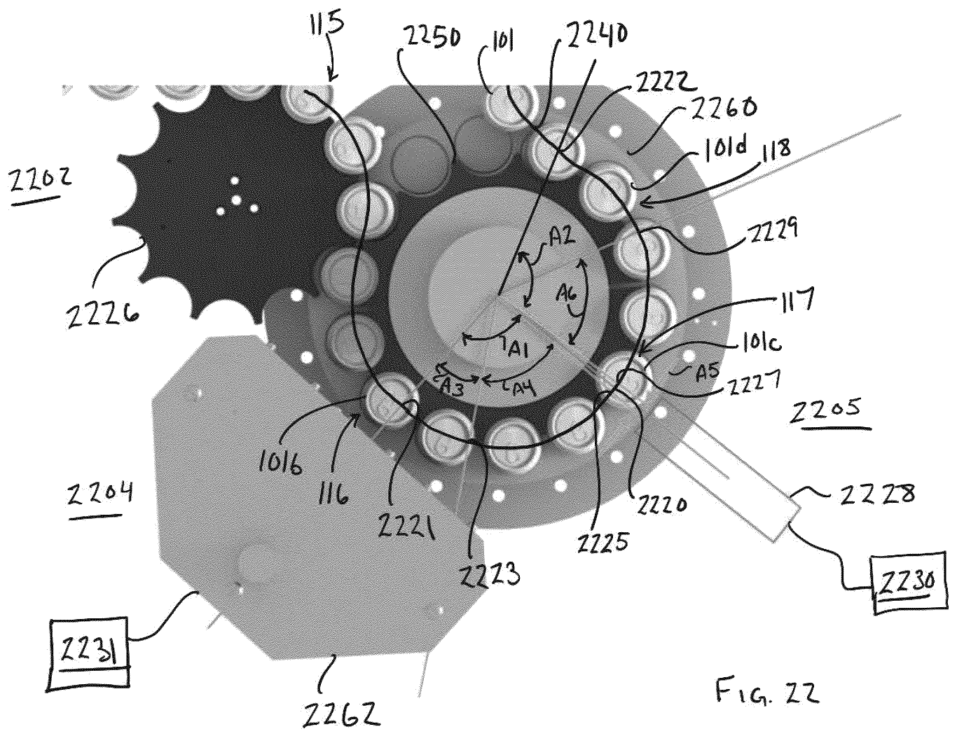

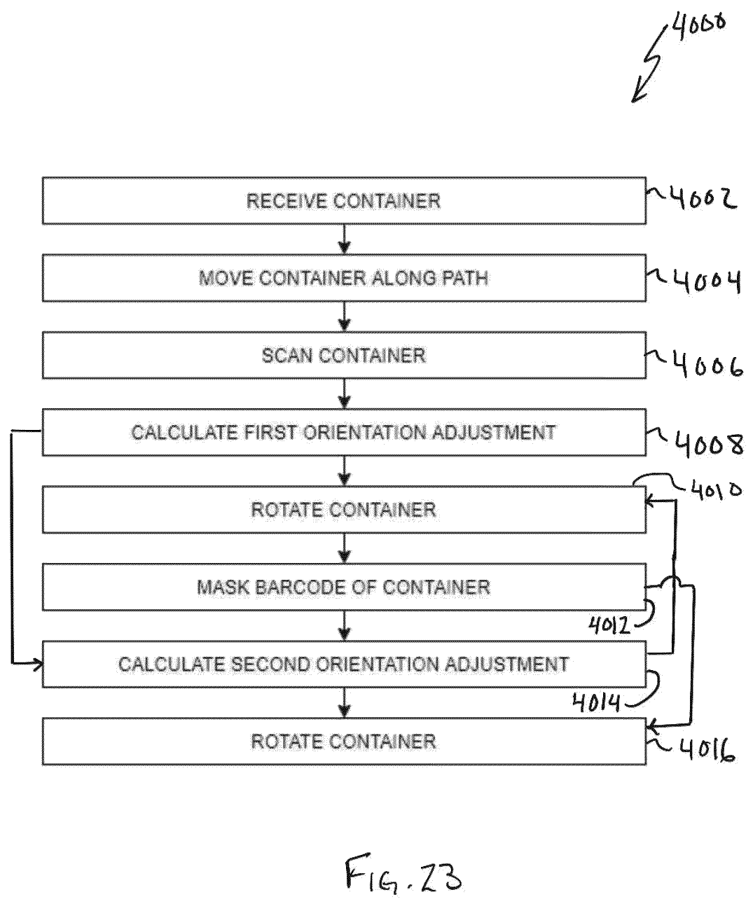

Referring now to FIG. 22, which illustrates an example of a portion of system 100 and, more particularly, a portion of conveying module 2202, a portion of orienting module 2204 and a portion of masking module 2205. The example of system 100 shown in FIG. 22 shares many common features with the examples of system 100 shown in FIGS. 1-21. In the example of system 100 shown in FIG. 22, like numerals have, where possible, been used to denote like parts, albeit with the addition of the prefix “2200” to indicate that these features belong to another example of system 100.

FIG. 22 depicts second star-wheel 2226 of conveying module 2202, which supplies stream 115 of containers 101 to orienting module 2204 in initial orientation 116. FIG. 22 also depicts masking apparatus 2228 of masking module 2205, which masks at least a portion of barcode 103 (not shown in FIG. 22) of container 101. FIG. 22 further depicts camera 2262, third star-wheel 2250 and base 2260 of orienting module 2204, which properly orients at least one container 101 to masking orientation 117 for the masking operation performed by masking apparatus 2228 and subsequently orients at least one container 101 to packing orientation 118 after the masking operation.

As shown in FIG. 22, in one or more examples, a circular portion of path 2240 is formed by rotation of container 101 about a central rotational axis of third star-wheel 2250. In other words, along the circular portion of path 2240, container 101 revolved about the rotational axis of third star-wheel 2250. Accordingly, in one or more examples, container 101 is scanned by camera 2262 at scanning location 2221 along path 2240 (e.g., along the circular portion of path 2240). Generally, scanning location 2221 is a position along path 2240 at which the scanning operation is performed using camera 2262. Further, in one or more examples, container 101 is handed off from orienting module 2204 to the grouping module (not shown in FIG. 22) at a transferring location 2222 along path 2240. Generally, transferring location 2222 is a position along path 2240 at which container 101 is moved away from third star-wheel 2250.

Masking location 2220 along path 2240 is at first angular displacement A1 from scanning location 2221. Similarly, transferring location 2222 is at second angular displacement A2 from masking location 2220. Generally, first angular displacement A1 and second angular displacement A2 are known and is based on the relative locations of camera 2262 and masking apparatus 2228.

Orienting module 2204 is configured to complete rotation of container 101 from initial orientation 116 to masking orientation 117 (e.g., effectuate rotation of container 101 by the first angle of rotation) between scanning location 2221 and masking location 2220. A distance that container 101 moves from scanning location 2221 to masking location 2220 is known and is based on the diameter of third star-wheel 2250, the diameter of container 101 and first angular displacement A1. The time available to effectuate rotation of container 101 from initial orientation 116 to masking orientation 117 is based on the diameter of third star-wheel 2250, the diameter of container 101, first angular displacement A1 and rotational velocity of third star-wheel 2250. Accordingly, operational speed of camera 2262, processing speed of processor 2231, rotational velocity of third star-wheel 2250 and rotational velocity of container 101 (e.g., as rotated by the turning member) are coordinated or synced such that rotation of container 101 from initial orientation 116 to masking orientation 117 is completed between scanning location 2221 and masking location 2220.

In an example, camera 2262 is adapted to scan container 101 (e.g., capture image of container 101) when container 101 passes scanning location 2221. Processor 2231 is adapted to process and analyze the image (or other data) representing container 101 at initial orientation 116 (e.g., initially oriented container 101b) and calculate the first angle of rotation needed to effectuate a first rotation of container 101 from initial orientation 116 to masking orientation 117 within a portion of one rotation of third star-wheel 2250 that is less than first angular displacement A1 between scanning location 2221 and masking location 2220.

In an example, processor 2231 analyzes the image and calculates the first angle of rotation before container 101 reaches first rotating location 2223 along path 2240, which is at third angular displacement A3 from scanning location 2221. Generally, first rotating location 2223 is a position along scan path 2240 at which rotation of container 101 from initial orientation 116 to masking orientation 117 starts.

The turning member (e.g., turning member 1064, 1164 shown in FIGS. 10 and 11) of orienting module 2204 is adapted to rotate container 101 at a rotational velocity sufficient to complete rotation of container 101 by the first angle of rotation before container 101 reaches second rotating location 2225 along scan path 2240, which is at fourth angular displacement A4 from first rotating location 2223. Generally, second rotating location 2225 is a position along scan path 2240 at which rotation of container 101 from initial orientation 116 to masking orientation 117 ends.

Masking apparatus 2228 is adapted to apply mask 119 (not shown in FIG. 22) to at least a portion of barcode 103 (not shown in FIG. 22) at masking location 2220. Generally, masking location 2220 is between second rotating location 2225 and third rotating location 2227 along scan path 2240, which is at fifth angular displacement from second rotating location 2225. Generally, third rotating location 2227 is a position along scan path 2240 at which rotation of container 101 from masking orientation 117 to packing orientation 118 starts. Container 101 is generally rotationally stationary along scan path 2240 between second rotating location 2225. and third rotating location 2227 for application of mask 119 to barcode 103.

Orienting module 2204 is configured to complete rotation of container 101 from masking orientation 117 to packing orientation 118 (e.g., effectuate rotation of container 101 by the second angle of rotation) between masking location 2220 and transferring location 2222. A distance that container 101 moves from masking location 2220 to transferring location 2222 is known and is based on the diameter of third star-wheel 2250, the diameter of container 101 and second angular displacement A2. The time available to effectuate rotation of container 101 from masking orientation 117 to packing orientation 118 is based on the diameter of third star-wheel 2250, the diameter of container 101, second angular displacement A2 and rotational velocity of third star-wheel 2250. Accordingly, processing speed of processor 2231, rotational velocity of third star-wheel 2250 and rotational velocity of container 101 (e.g., as rotated by the turning member) are coordinated or synced such that rotation of container 101 from masking orientation 117 to packing orientation 118 is completed between masking location 2220 and transferring location 2222.

In an example, processor 2231 analyzes the image and calculates the second angle of rotation before container 101 reaches third rotating location 2227 along path 2240. The turning member (e.g., turning member 1064, 1164 shown in FIGS. 10 and 11) of orienting module 2204 is adapted to rotate container 101 at a rotational velocity sufficient to complete rotation of container 101 by the second angle of rotation before container 101 reaches fourth rotating location 2229 along scan path 2240, which is at sixth angular displacement A6 from third rotating location 2227. Generally, fourth rotating location 2229 is a position along scan path 2240 at which rotation of container 101 from masking orientation 117 to packing orientation 118 ends. Generally, fourth rotating location 2229 is ahead of or upstream of transferring location 2222.

Generally, the first angle of rotation from initial orientation 116 to masking orientation 117 is less than or equal to 180 degrees (e.g., in clockwise or counterclockwise directions). Similarly, the second angle of rotation from masking orientation to packing orientation 118 is less than or equal to 180 degrees (e.g., in clockwise or counterclockwise directions).

Referring generally to FIGS. 1-22 and particularly to FIG. 23, by way of examples, the present disclosure directed to method 4000 for packaging containers 101 and, more particularly, for masking barcode 103 of at least one container 101 of stream 115 of containers 101 during packaging. Additionally, examples of method 4000 enable packing and orienting barcode-masked containers 101e (e.g., as shown in FIG. 19B) for creating packages of containers 101. More particularly, examples of method 4000 facilitate metering of stream 115 of containers 101, orienting each one of containers 101 is masking orientation 117, masking at least a portion of barcode 103 of at least one container 101 and orienting containers 101 in packing orientation 118 for a grouping and packaging operation.

Referring to FIG. 23, in one or more examples, method 4000 includes a step of (block 4002) receiving container 101. In one or more examples, stream 115 of containers 101 is supplied to the orienting module by the conveying module.

In one or more examples, method 4000 includes a step of (block 4004) moving container 101 along the path. In one or more examples, container 101 is moved along a portion of the path by the orienting module.

In one or more examples, method 4000 includes a step of (block 4006) scanning container 101 as container moves along the path. In one or more examples, container 101 is scanned in initial orientation 116 at the scanning location along the path by the camera.

In one or more examples, method 4000 includes a step of (block 4008) calculating a first orientation adjustment from initial orientation 116 to masking orientation 117 for container 101. In one or more examples, the first orientation adjustment is calculated based on an analysis of the scan of container 101 (e.g., captured image) and is expressed herein above as the first angle of rotation.

In one or more examples, method 4000 includes a step of (block 4010) rotating container 101 to effectuate the first orientation adjustment. In one or more examples, container 101 is rotated by the first angle of rotation from initial orientation 116 to masking orientation 117 using the orientation module.

In one or more examples, method 4000 includes a step of (block 4012) masking at least a portion of barcode 103 of container 101. In one or more examples, mask 119 is applied to at least a portion of barcode 103 with container 101 in masking orientation 117 and at the masking location along the path.

In one or more examples, the step of (block 4012) masking at least a portion of barcode 103 includes a step of applying ink over at least the portion of barcode 103 using the masking apparatus.

In one or more examples, the step of (block 4012) masking at least a portion of barcode 103 includes a step of removing at least the portion of barcode 103 using the masking apparatus.

In one or more examples, method 4000 includes a step of (block 4014) calculating a second orientation adjustment from masking orientation 117 to packing orientation 118 for container 101. In one or more examples, the second orientation adjustment is calculated based on an analysis of the scan of container 101 (e.g., captured image) and is expressed herein above as the second angle of rotation.

In one or more examples, the step of (block 4008) calculating the first orientation adjustment and the step of (block 4014) calculating the second orientation adjustment are performed together. For example, the first orientation adjustment is calculated or otherwise determined (block 4008) and the second orientation adjustment is calculated or otherwise determined (block 4014) before rotation of container 101 to effectuate the first orientation adjustment (block 4010). As such, in one or more examples, masking orientation 117 and packing orientation 118 are calculated or otherwise determined approximately concurrently.

In one or more examples, the step of (block 4008) calculating the first orientation adjustment and the step of (block 4014) calculating the second orientation adjustment are performed separately or sequentially. For example, the first orientation adjustment is calculated or otherwise determined (block 4008) before rotation of container 101 to effectuate the first orientation adjustment (block 4010) and the second orientation adjustment is calculated or otherwise determined (block 4014) after the first orientation adjustment is calculated (block 4008) and before rotation of container 101 to effectuate the second orientation adjustment (block 4016). As such, in one or more examples, masking orientation 117 and packing orientation 118 are calculated or otherwise determined at different times.

In one or more examples, method 4000 includes a step of (block 4016) rotating container 101 to effectuate the second orientation adjustment. In one or more examples, container 101 is rotated by the second angle of rotation from masking orientation 1117 to packing orientation 118 using the orientation module.

The preceding detailed description refers to the accompanying drawings, which illustrate specific examples of the disclosed system, gripper and method described by the present disclosure. It will be understood that the disclosed examples are merely exemplary embodiments of the way in which certain aspects of the of the disclosed system, gripper and method can be implemented and do not represent an exhaustive list of all of the ways the of the disclosed system, gripper and method may be embodied. Other examples having different structures and operations do not depart from the scope of the present disclosure.

Well-known components, materials or methods are not necessarily described in detail in order to avoid obscuring the present disclosure. Any specific structural and functional details disclosed herein are not meant to be interpreted as limiting, but merely as a basis for the claims and as a representative basis for teaching one skilled in the art to variously employ the invention.

Like reference numerals may refer to the same feature, element, or component in the different drawings. The figures are not necessarily to scale and some features may be exaggerated or minimized to show details of particular components.

Throughout the present disclosure, any one of a plurality of items may be referred to individually as the item and a plurality of items may be referred to collectively as the items. Moreover, as used herein, a feature, element, component, or step preceded with the word “a” or “an” should be understood as not excluding a plurality of features, elements, components or steps, unless such exclusion is explicitly recited.

Illustrative, non-exhaustive examples, which may be, but are not necessarily, claimed, of the subject matter according to the present disclosure are provided above. Reference herein to “example” means that one or more feature, structure, element, component, characteristic, and/or operational step described in connection with the example is included in at least one aspect, embodiment, and/or implementation of the subject matter according to the present disclosure. Thus, the phrases “an example,” “another example,” “one or more examples,” and similar language throughout the present disclosure may, but do not necessarily, refer to the same example. Further, the subject matter characterizing any one example may, but does not necessarily, include the subject matter characterizing any other example. Moreover, the subject matter characterizing any one example may be, but is not necessarily, combined with the subject matter characterizing any other example.

It is to be understood that not necessarily all objects or advantages may be achieved in accordance with any particular example described herein. Thus, for example, those skilled in the art will recognize that certain examples may be configured to operate in a manner that achieves or optimizes one advantage or group of advantages as taught herein without necessarily achieving other objects or advantages as may be taught or suggested herein.

Conditional language such as, among others, “can” or “may,” unless specifically stated otherwise, are otherwise understood within the context as used in general to convey that certain examples include, while other examples do not include, certain features, elements and/or steps. Thus, such conditional language is not generally intended to imply that features, elements and/or steps are in any way required for one or more examples or that one or more examples necessarily include logic for deciding, with or without user input or prompting, whether these features, elements and/or steps are included or are to be performed in any particular example.

Unless otherwise indicated, the terms “first,” “second,” “third,” etc. are used herein merely as labels, and are not intended to impose ordinal, positional, or hierarchical requirements on the items to which these terms refer. Moreover, reference to, e.g., a “second” item does not require or preclude the existence of, e.g., a “first” or lower-numbered item, and/or, e.g., a “third” or higher-numbered item.

Those skilled in the art will appreciate that not all elements described and illustrated in FIGS. 1-22 need be included in every example and not all elements described herein are necessarily depicted in each illustrative example. FIGS. 1-22, referred to above, may represent functional elements, features, or components thereof and do not necessarily imply any particular structure. Accordingly, modifications, additions and/or omissions may be made to the illustrated structure. Additionally, those skilled in the art will appreciate that not all elements, features, and/or components described and illustrated in FIGS. 1-22, referred to above, need be included in every example and not all elements, features, and/or components described herein are necessarily depicted in each illustrative example. Accordingly, some of the elements, features, and/or components described and illustrated in FIGS. 1-22 may be combined in various ways without the need to include other features described and illustrated in FIGS. 1-22, other drawing figures, and/or the accompanying disclosure, even though such combination or combinations are not explicitly illustrated herein. Similarly, additional features not limited to the examples presented, may be combined with some or all of the features shown and described herein. Unless otherwise explicitly stated, the schematic illustrations of the examples depicted in FIGS. 1-22, referred to above, are not meant to imply structural limitations with respect to the illustrative example. Rather, although one illustrative structure is indicated, it is to be understood that the structure may be modified when appropriate. Accordingly, modifications, additions and/or omissions may be made to the illustrated structure. Furthermore, elements, features, and/or components that serve a similar, or at least substantially similar, purpose are labeled with like numbers in each of FIGS. 1-22, and such elements, features, and/or components may not be discussed in detail herein with reference to each of FIGS. 1-22. Similarly, all elements, features, and/or components may not be labeled in each of FIGS. 1-22, but reference numerals associated therewith may be utilized herein for consistency.

Further, references throughout the present specification to features, advantages, or similar language used herein do not imply that all of the features and advantages that may be realized with the examples disclosed herein should be, or are in, any single example. Rather, language referring to the features and advantages is understood to mean that a specific feature, advantage, or characteristic described in connection with an example is included in at least one example. Thus, discussion of features, advantages, and similar language used throughout the present disclosure may, but do not necessarily, refer to the same example.

The described features, advantages, and characteristics of one example may be combined in any suitable manner in one or more other examples. One skilled in the relevant art will recognize that the examples described herein may be practiced without one or more of the specific features or advantages of a particular example. In other instances, additional features and advantages may be recognized in certain examples that may not be present in all examples. Furthermore, although various examples of the system, the masking module and method have been shown and described, modifications may occur to those skilled in the art upon reading the specification. The present application includes such modifications and is limited only by the scope of the claims.

What is claimed is:

1. A masking module comprising:
a masking apparatus situated proximate to a path of a container and configured to apply a mask to at least a portion of a barcode of the container as the container moves along the path; and
a controller in communication with the masking apparatus and configured to selectively actuate the masking apparatus when the container passes by the masking apparatus along the path.

2. The masking module of claim 1, wherein the container is selectively oriented in a masking orientation relative to the masking apparatus before the container passes by the masking apparatus along the path.

3. The masking module of claim 2, wherein:
the container is selectively rotated from an initial orientation to the masking orientation before the container passes by the masking apparatus along the path; and
the container is selectively rotated from the masking orientation to a packing orientation after the container passes by the masking apparatus along the path.

4. The masking module of claim 1, wherein the masking apparatus comprises an inkjet printer configured to apply ink over at least a portion of the barcode.

5. The masking module of claim 1, wherein the masking apparatus comprises a laser printer configured to apply ink over at least a portion of the barcode.

6. The masking module of claim 1, wherein the masking apparatus comprises a laser etcher configured to remove at least a portion of the barcode.

7. A system for packing containers, the system comprising:
an orienting module configured to receive a container, to guide the container along a portion of a path, and to orient the container in a masking orientation at a masking location along the path; and
a masking module configured to apply a mask to at least a portion of a barcode of the container as the container passes the masking location along the path.

8. The system of claim 7, wherein the masking module comprises:
a masking apparatus situated proximate to the path of the container and configured to apply the mask to at least a portion of the barcode of the container; and
a controller in communication with the masking apparatus and configured to selectively actuate the masking apparatus when the container is at the masking location along the path.

9. The system of claim 8, wherein the masking apparatus comprises an inkjet printer configured to apply ink over at least a portion of the barcode.

10. The system of claim 9, wherein the masking apparatus comprises a laser printer configured to apply ink over at least a portion of the barcode.

11. The system of claim 9, wherein the masking apparatus comprises a laser etcher configured to remove at least a portion of the barcode.

12. The system of claim 8, wherein the orienting module is configured to selectively rotate the container from an initial orientation to the masking orientation before the container passes by the masking location along the path.

13. The system of claim 12, wherein the orienting module is further configured to selectively rotate the container from the masking orientation to a packing orientation after the container passes by the masking location along the path.

14. The system of claim 13, further comprising:
a conveying module configured to transfer the container to the orienting module in the initial orientation; and
a grouping module configured to receive the container from the orienting module in the packing orientation.

15. The system of claim 13, wherein the orienting module comprises:
a camera situated to capture an image of the container as the container moves along the path in the initial orientation;
a processor coupled to the camera and configured to analyze the image of the container and to determine a first angle of rotation from the initial orientation to the masking orientation; and
a turning member configured to rotate the container by the first angle of rotation according to a first command from the processor.

16. The system of claim 15, wherein:
the processor is further configured to analyze the image of the container and to determine a second angle of rotation from the masking orientation to the packing orientation; and
the turning member is further configured to rotate the container by the second angle of rotation according to a second command from the processor.

17. A method for packaging containers, the method comprising steps of:
receiving a container;
moving the container along a path;
scanning the container as the container moves along the path;
calculating a first orientation adjustment from an initial orientation to a masking orientation for the container;
rotating the container to effectuate the first orientation adjustment; and
masking at least a portion of a barcode of the container.

18. The method of claim 17, further comprising:
calculating a second orientation adjustment from the masking orientation to a packing orientation for the container; and
rotating the container to effectuate the second orientation adjustment.

19. The method of claim 18, wherein the step of masking at least the portion of the barcode of the container comprises applying ink over at least the portion of the barcode.

20. The method of claim 18, wherein the step of masking at least a portion of the barcode of the container comprises removing at least the portion of the barcode.
